(19) United States
(12) Patent Application Publication
(10) Pub. No.: US 2024/0361213 A1
(43) Pub. Date: Oct. 31, 2024

(54) MATERIALS AND METHODS FOR BLEACHING MELANIN-PIGMENTED TISSUES

(71) Applicant: Ventana Medical Systems, Inc., Tucson, AZ (US)

(72) Inventors: Sheelah Ching CHANGHO, Chandler, AZ (US); Michael Allen GURNEY, Tucson, AZ (US); Grishma KHANAL, Oro Valley, AZ (US); Laurel Anne Katharine MCKEE, Tucson, AZ (US); John Douglas PALTING, Tucson, AZ (US); Woody Yuh-Fan PERNG, Oro Valley, AZ (US)

(21) Appl. No.: 18/766,072

(22) Filed: Jul. 8, 2024

Related U.S. Application Data
(63) Continuation of application No. PCT/US2023/060929, filed on Jan. 19, 2023.
(60) Provisional application No. 63/302,836, filed on Jan. 25, 2022.

(51) Int. Cl. G01N 1/31; G01N 1/30

(52) U.S. Cl. CPC G01N 1/31; G01N 2001/302

(57) ABSTRACT

A method of depigmenting melanin-pigmented samples is provided. The sample is incubated in the presence of a hydrogen peroxide-based solution at a temperature less than 65° C. for up to 180 minutes. Times, temperatures, and concentrations of hydrogen peroxide that appropriately balance extent of depigmentation with maintenance of cellular morphology and sample retention are also disclosed.

### CROSS REFERENCE TO RELATED APPLICATIONS

The present application is a continuation of International Application No. PCT/US2023/060929, filed on Jan. 19, 2023, which application claims the benefit of the filing date of U.S. Provisional Patent Application No. 63/302,836 filed on Jan. 25, 2022, the disclosures of which are hereby incorporated herein by reference in their entirety.

### TECHNICAL FIELD

The present disclosure relates to materials and methods useful in the field of preparation of cellular samples for microscopic analysis, especially for pigmented tissues.

### BACKGROUND

Melanins are naturally occurring, stable, and insoluble pigments present in neoplastic and non-neoplastic tissues and can impede histopathologic assessment of melanocytic lesions by obscuring cellular morphology. Additionally, chromogens used in immunohistochemical (IHC) analysis can be masked by the brown-black pigment, complicating IHC biomarker assessment and thus patient diagnosis.

Various manual and semi-automated protocols have been outlined in the literature for mitigating these issues.

Chung et al., describes a manual protocol for using 0.5% hydrogen peroxide (H₂O₂) as a bleaching reagent to remove excessive melanin from heavily pigmented formalin-fixed paraffin-embedded (FFPE) melanoma tissues with a thickness of 5 μm, followed by immunohistochemical (IHC) staining for various biomarkers. The results were visualized with and the tissue morphology was preserved. An 0.5% H₂O₂ solution at a relatively high temperature incubation was used (80° C.) was used.

Liu et al. describe a process on an automated immunohistochemical staining platform using hydrogen peroxide diluted in phosphate buffered saline at 65° C. to depigment melanin in ocular and cutaneous melanoma samples with a thickness of 3 μm.

In Manicam et al., the effect of different bleaching reagents and conditions on the removal of melanin was evaluated. The study was limited to hematoxylin and cosin (H&E) staining after bleaching; no testing was done on IHC staining.

Momose et al. tested the bleaching performance of H₂O₂ in different buffers with various incubation times. IHC staining using various biomarkers (i.e., lymphoid tissue, melanocyte, endothelial, cytokeratin, desmin, and Ki-67) were tested after the bleaching step. The effect of the sequential order of antigen retrieval and melanin depigmentation on preserving tissue morphology was evaluated. The optimized melanin depigmentation process was done manually using “warm” diluted (i.e., 3%, 55° C.) H₂O₂ solutions for 2 hours after antigen retrieval.

Orchard et al. (2019) described a semi-automated bleaching procedure in which various biomarkers were tested, including Mart 1, S-100, Sox-10, HMB45, and CD68. However, the bleaching procedure was performed off of the staining system. Additionally, very high concentrations of H₂O₂ (10% final concentration in PBS) were used.

Foss et al. investigated the effect of bleaching using potassium permanganate on antigens and IHC staining procedure (i.e., pre- and post-antigen retrieval, post-antibody introduction, post-detection chemistry). They found that the order of bleaching before or after antigen retrieval made no difference to the antigenicity but significantly affected tissue loss. Little tissue loss was observed when bleaching followed antigen retrieval. Detection chemistry also proved to be sensitive to oxidation, resulting in decolorized reaction products.

Orchard (2007) investigated the effect of temperature on the efficiency of melanin bleaching was investigated. Following bleaching, various biomarkers were employed such as S100, HMB45, NKIC3, Melan-A, CD3, CD20, CD68, CD34, CD45, CD31, and SMA. Melanin bleaching was demonstrated to be more efficient under higher temperature (i.e., 60° C.) than at temperatures closer to room temperature (i.e., 37° C.).

McGovern et al. applied different bleaching formulations to melanotic malignant melanoma, before and after an immunoperoxidase staining sequence. Tissues were stained with S100 and NSE biomarkers. Pretreatment using potassium permanganate and oxalic acid was found to be the optimal bleaching method.

Hu et al. tested various bleaching conditions (i.e., various time, temperature, concentration of H₂O₂) on IHC staining using Sox-10, S-100, HMB45 and Melan-A. They found an optimized bleaching condition of 30% H₂O₂ for 24 hours at 24° C.

To the best of our knowledge, a fully automated protocol has not yet been developed that appropriately balances adequate depigmentation, flexibility of antigen retrieval, preservation of morphology, and mitigation of tissue loss.

### BRIEF SUMMARY

It is against the above background that the embodiments of the present disclosure provide certain unobvious advantages and advancements over the prior art. In particular, the inventors have recognized a need for improvements in materials and methods for bleaching melanin-pigmented tissues.

Although the embodiments of the present disclosure are not limited to specific advantages or functionality, it is noted that the present disclosure relates to methods, reagents, and devices for removing melanin pigmentation from cellular samples using a hydrogen peroxide solution. The disclosed methods are full automatable and result in samples that are depigmented enough to permit IHC analysis while also preserving adequate cellular morphology and limiting sample loss. The disclosed methods generally involve incubating a cellular sample in a buffered aqueous H₂O₂ solution at a concentration of up to 5% at a temperature of less than 65° C. for up to 180 minutes. An automated method of affinity staining a cellular sample integrating the disclosed methods is also disclosed, as well as devices and reagents for performing the same.

These and other features and advantages of the embodiments of the present disclosure will be more fully understood from the following description in combination with the drawings and accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present disclosure can be best understood when read in conjunction with the following drawings, where like structure is indicated with like reference numerals and in which:

FIG. 1 illustrates an exemplary automated workflow for depigmenting melanin-pigmented samples on an automated affinity stainer;

FIG. 2 is a series of images illustrating an automated depigmenting method;

FIG. 3A is a Pareto chart derived from Table 3;

FIG. 3B is a main effects chart derived from Table 3;

FIG. 3C is an interaction plot derived from Table 3;

FIG. 4A is a Pareto chart derived from Table 5;

FIG. 4B is a main effects chart derived from Table 5;

FIG. 4C is an interaction plot derived from Table 5;

FIG. 5 is a series of representative images of the Concentration and Time Optimization at 37° C. and 50° C.;

FIG. 6 is a series of representative images of the evaluation of long incubation times;

FIG. 7 is a series of representative images of the evaluation of diluent composition and puddle conditions;

FIG. 8 illustrates the effect of Tris concentration in various puddle buffers on depigmentation performance;

FIG. 9 illustrates stability testing of a 10% H₂O₂ stock solution based on change in pH over time in a variety of diluents;

FIG. 10 illustrates stability testing of a 10% H₂O₂ stock solution based on change in H₂O₂ concentration over time in a variety of diluents;

FIG. 11A shows the melanin intensity in high melanin cases with 1-20% stock solution H₂O₂ in water (0.25%-5% working concentration in 75 mM Tris) at 37° C. for 92 minutes;

FIG. 11B shows the melanin percent coverage in high melanin cases with 1-20% stock solution H₂O₂ in water (0.25%-5% working concentration in 75 mM Tris) at 37° C. for 92 minutes;

FIG. 11C shows representative images of samples depigmented with 1-20% stock solution H₂O₂ (0.25%-5% working concentration in 75 mM Tris) in water at 37° C. for 92 minutes;

FIG. 11D shows representative images of samples depigmented with 1-20% stock solution H₂O₂ in water (0.25%-5% working concentration in 75 mM Tris) at 37° C. for 92 minutes and immunohistochemically stained for LAG3;

FIG. 12A shows representative images of samples depigmented with 10% H₂O₂ stock solution in water (2.5% working concentration in 75 mM Tris) for 92 minutes at room temperature (20° C.), 37° C., 45° C., 55° C., 65° C., or 75° C.;

FIG. 12B shows the melanin intensity in high melanin cases with 10% H₂O₂ stock solution in water (2.5% working concentration in 75 mM Tris) for 92 minutes at room temperature (20° C.), 37° C., 45° C., 55° C., 65° C., or 75° C.;

FIG. 12C shows the melanin percent coverage in high melanin cases with 10% H₂O₂ in water (2.5% working concentration in 75 mM Tris) for 92 minutes at room temperature (20° C.), 37° C., 45° C., 55° C., 65° C., or 75° C.;

FIG. 13A shows the melanin intensity in high melanin cases with 10% stock solution H₂O₂ in water (2.5% working concentration in 75 mM Tris) at 37° C. for 64, 72, 80, 92, or 180 minutes;

FIG. 13B shows the melanin percent coverage in high melanin cases with 1-20% stock solution H₂O₂ in water (2.5% working concentration in 75 mM Tris) at 37° C. for 64, 72, 80, 92, or 180 minutes; and

FIG. 13C shows representative images of samples depigmented with 1-20% stock solution H₂O₂ (2.5% working concentration in 75 mM Tris) in water at 37° C. for 64, 72, 80, 92, or 180 minutes.

Skilled artisans appreciate that elements in the figures are illustrated for simplicity and clarity and have not necessarily been drawn to scale. For example, the dimensions of some of the elements in the figures may be exaggerated relative to other elements to help improve understanding of the embodiments of the present disclosure.

### DETAILED DESCRIPTION

### I. Abbreviations and Definitions

Unless defined otherwise, technical and scientific terms used herein have the same meaning as commonly understood by a person of ordinary skill in the art. See, e.g., Lackie, DICTIONARY OF CELL AND MOLECULAR BIOLOGY, Elsevier (4th ed. 2007); Sambrook et al., MOLECULAR CLONING, A LABORATORY MANUAL, Cold Springs Harbor Press (Cold Springs Harbor, N.Y. 1989). The term “a” or “an” is intended to mean “one or more.” The terms “comprise,” “comprises,” and “comprising,” when preceding the recitation of a step or an element, are intended to mean that the addition of further steps or elements is optional and not excluded.

Affinity detection: A process involving labelling biomarkers in a cellular sample with biomarker-specific reagents and detection reagents in a manner that permits microscopic detection of the biomarker. Examples include immunohistochemistry (IHC), chromogenic in situ hybridization (CISH), fluorescent in situ hybridization (FISH), and silver in situ hybridization (SISH) staining of formalin-fixed, paraffin-embedded tissue sections.

Antibody: The term “antibody” herein is used in the broadest sense and encompasses various antibody structures, including but not limited to monoclonal antibodies, polyclonal antibodies, multispecific antibodies (e.g., bispecific antibodies), and antibody fragments so long as they exhibit the desired antigen-binding activity.

Antibody fragment: An “antibody fragment” refers to a molecule other than an intact antibody that comprises a portion of an intact antibody that binds the antigen to which the intact antibody binds. Examples of antibody fragments include but are not limited to Fv, Fab, Fab,′ Fab′-SH, F (ab′) 2; diabodies; linear antibodies; single-chain antibody molecules (e.g., scFv); and multispecific antibodies formed from antibody fragments.

Biomarker: As used herein, the term “biomarker” shall refer to any molecule or group of molecules found in a biological sample that can be used to characterize the biological sample or a subject from which the biological sample is obtained. For example, a biomarker may be a molecule or group of molecules whose presence, absence, or relative abundance is characteristic of: a particular cell or tissue type or state; a particular pathological condition or state; or the severity of a pathological condition, the likelihood of progression or regression of the pathological condition, and/or the likelihood that the pathological condition will respond to a particular treatment. As another example, the biomarker may be a cell type or a microorganism (such as a bacterium, mycobacterium, fungus, virus, and the like), or a substituent molecule or group of molecules thereof.

Biomarker-specific reagent: A specific detection reagent that is capable of specifically binding directly to one or more biomarkers in the cellular sample, such as a primary antibody.

Cellular sample: As used herein, the term “cellular sample” refers to any sample containing intact cells, such as cell cultures, bodily fluid samples or surgical specimens taken for pathological, histological, or cytological interpretation.

DAB: 3,3′-diaminobenzidine.

Detection reagent: A “detection reagent” is any reagent that is used to deposit a detectable moiety in proximity to a biomarker-specific reagent in a cellular sample. Non-limiting examples include biomarker-specific reagents (such as primary antibodies), secondary detection reagents (such as secondary antibodies capable of binding to a primary antibody), tertiary detection reagents (such as tertiary antibodies capable of binding to secondary antibodies), enzymes directly or indirectly associated with the biomarker specific reagent, chemicals reactive with such enzymes to effect deposition of a detectable moiety (such as a fluorescent or chromogenic stain), wash reagents used between staining steps, and the like.

Detectable moiety: A molecule or material that can produce a detectable signal (such as visually, electronically or otherwise) that indicates the presence and/or amount of the detectable moiety deposited on a sample. A detectable signal can be generated by any known or yet to be discovered mechanism including absorption, emission and/or scattering of a photon (including radio frequency, microwave frequency, infrared frequency, visible frequency and ultra-violet frequency photons). The term “detectable moiety” includes chromogenic, fluorescent, phosphorescent, and luminescent molecules and materials, catalysts (such as enzymes) that convert one substance into another substance to provide a detectable difference (such as by converting a colorless substance into a colored substance or vice versa, or by producing a precipitate or increasing sample turbidity). In some examples, the detectable moiety is a fluorophore, which belongs to several common chemical classes including coumarins, fluoresceins (or fluorescein derivatives and analogs), rhodamines, resorufins, luminophores and cyanines. Additional examples of fluorescent molecules can be found in Molecular Probes Handbook-A Guide to Fluorescent Probes and Labeling Technologies, Molecular Probes, Eugene, OR, ThermoFisher Scientific, 11th Edition. In other embodiments, the detectable moiety is a molecule detectable via brightfield microscopy, such as dyes including diaminobenzidine (DAB), 4-(dimethylamino) azobenzene-4′-sulfonamide (DABSYL), tetramethylrhodamine (DISCOVERY Purple), N,N′-biscarboxypentyl-5,5′-disulfonato-indo-dicarbocyanine (Cy5), and Rhodamine 110 (Rhodamine).

Monoclonal antibody: An antibody obtained from a population of substantially homogencous antibodies, i.e., the individual antibodies comprising the population are identical and/or bind the same epitope, except for possible variant antibodies, e.g., containing naturally occurring mutations or arising during production of a monoclonal antibody preparation, such variants generally being present in minor amounts. In contrast to polyclonal antibody preparations, which typically include different antibodies directed against different determinants (epitopes), each monoclonal antibody of a monoclonal antibody preparation is directed against a single determinant on an antigen. Thus, the modifier “monoclonal” indicates the character of the antibody as being obtained from a substantially homogeneous population of antibodies and is not to be construed as requiring production of the antibody by any particular method. For example, the monoclonal antibodies to be used in accordance with the present disclosure may be made by a variety of techniques, including but not limited to the hybridoma method, recombinant DNA methods, phage-display methods, and methods utilizing transgenic animals containing all or part of the human immunoglobulin loci, or a combination thereof.

NRC: Negative reagent control.

Sample: As used herein, the term “sample” shall refer to any material obtained from a subject capable of being tested for the presence or absence of a biomarker.

Secondary detection reagent: A specific detection reagent capable of specifically binding to a biomarker-specific reagent.

Section: When used as a noun, a thin slice of a tissue sample suitable for microscopic analysis, typically cut using a microtome. When used as a verb, the process of generating a section.

Specific detection reagent: Any composition of matter that is capable of specifically binding to a target chemical structure in the context of a cellular sample. As used herein, the phrase “specific binding,” “specifically binds to,” or “specific for” or other similar iterations refers to measurable and reproducible interactions between a target and a specific detection reagent, which is determinative of the presence of the target in the presence of a heterogeneous population of molecules including biological molecules. For example, an antibody that specifically binds to a target is an antibody that binds this target with greater affinity, avidity, more readily, and/or with greater duration than it binds to other targets. In one embodiment, the extent of binding of a specific detection reagent to an unrelated target is less than about 10% of the binding of the antibody to the target as measured, e.g., by a radioimmunoassay (RIA). In certain embodiments, a biomarker-specific reagent that specifically binds to a target has a dissociation constant (Kd) of ≤1 μM, ≤100 nM, ≤10 nM, ≤1 nM, or ≤0.1 nM. In another embodiment, specific binding can include, but does not require exclusive binding. Exemplary specific detection reagents include nucleic acid probes specific for particular nucleotide sequences; antibodies and antigen binding fragments thereof; and engineered specific binding compositions, including ADNECTINs (scaffold based on 10th FN3 fibronectin; Bristol-Myers-Squibb Co.), AFFIBODYs (scaffold based on Z domain of protein A from S. aureus; Affibody AB, Solna, Sweden), AVIMERs (scaffold based on domain A/LDL receptor; Amgen, Thousand Oaks, CA), dAbs (scaffold based on VH or VL antibody domain; GlaxoSmithKline PLC, Cambridge, UK), DARPINs (scaffold based on Ankyrin repeat proteins; Molecular Partners AG, Zürich, CH), ANTICALINs (scaffold based on lipocalins; Pieris AG, Freising, DE), NANOBODYs (scaffold based on VHH (camelid Ig); Ablynx N/V, Ghent, BE), TRANS-BODYs (scaffold based on Transferrin; Pfizer Inc., New York, NY), SMIPs (Emergent Biosolutions, Inc., Rockville, MD), and TETRANECTINs (scaffold based on C-type lectin domain (CTLD), tetranectin; Borcan Pharma A/S, Aarhus, DK). Descriptions of such engineered specific binding structures are reviewed by Wurch et al., Development of Novel Protein Scaffolds as Alternatives to Whole Antibodies for Imaging and Therapy: Status on Discovery Research and Clinical Validation, Current Pharmaceutical Biotechnology, Vol. 9, pp. 502-509 (2008), the content of which is incorporated by reference.

Stain: When used as a noun, the term “stain” shall refer to any substance that can be used to visualize specific molecules or structures in a cellular sample for microscopic analysis, including brightfield microscopy, fluorescent microscopy, electron microscopy, and the like. When used as a verb, the term “stain” shall refer to any process that results in deposition of a stain on a cellular sample.

Subject: As used herein, the term “subject” or “individual” is a mammal. Mammals include, but are not limited to, domesticated animals (e.g., cows, sheep, cats, dogs, and horses), primates (e.g., humans and non-human primates such as monkeys), rabbits, and rodents (e.g., mice and rats). In certain embodiments, the individual or subject is a human.

Test sample: A tumor sample obtained from a subject having an unknown outcome at the time the sample is obtained.

Tissue sample: As used herein, the term “tissue sample” shall refer to a cellular sample that preserves the cross-sectional spatial relationship between the cells as they existed within the subject from which the sample was obtained.

Tumor sample: A tissue sample obtained from a tumor.

### II. Depigmentation Method

The present inventors sought to identify a fully automatable methodology for removing melanin pigment from cellular samples that meets all of the following criteria: (A) reduces melanin pigment to a level that allows for specific interpretation of DAB-stained samples; (B) uses only reagent formulations that are shelf-stable, compatible with commercially-available staining devices, and have minimal environmental risk; (C) maintains acceptable morphology without unacceptable sample loss; and (D) does not substantially interfere with subsequent affinity histochemical or cytochemical analysis. While many depigmenting methodologies are known in the art, none were identified that satisfied each of these criteria. The present inventors discovered that a hydrogen peroxide depigmentation method could be adapted for use on an automated affinity staining platform that reaches each of the foregoing criteria.

### A. Sample

The sample is a cellular sample from melanin-pigmented tissue, such as a tissue sample (including biopsy sample or tumor resection) or a cytological sample (such as a fine needle aspirate). In some embodiments, the cellular sample is obtained from a subject having or suspected of having a tumor. In some embodiments, the sample is obtained directly from a tumor. In some embodiments, the tumor is a solid tumor, such as a carcinoma, lymphoma, or sarcoma. In an embodiment, cellular sample is from a suspected or confirmed melanoma. Where tissue samples are used, the tissue sample is processed in a manner compatible with histochemical staining, including, for example, fixation, embedding in a wax matrix (such as paraffin), and sectioning (such as with a microtome). No specific processing step is required by the present disclosure, so long as the sample obtained is compatible with affinity staining. In a specific embodiment, microtome sections of formalin-fixed, paraffin-embedded (FFPE) samples are used in the staining process.

### B. Bleaching Reaction Environment

The bleaching method is performed by contacting a cellular sample with an aqueous solution of hydrogen peroxide at a concentration of 1% to 5% (referred to herein as the H₂O₂ bleaching solution) and incubating the sample at a temperature less than 65° C. for up to 180 minutes. This combination of hydrogen peroxide concentration, temperature, and time has been found to a sufficient amount of melanin from the sample to allow interpretation of a DAB stain without causing substantial sample loss or unacceptable morphological changes.

The H₂O₂ bleaching solution comprises at least 1% and up to 5% (w/w) H₂O₂. Exemplary ranges of H₂O₂ concentrations that are expressly contemplated include from 1% to 5%, from 1.25% to 5%, from 2% to 5%, from 2.5% to 5%, from 2% to 4%, from 1.0% to 3%, from 1.0% to 2%, from 1.25% to 2.5%, from 2.0% to 3%, from 2.5% to 3.5%, from 3% to 4%, from 3.5% to 4.5%, from 4% to 5%, from 1.0% to 1.5%, from 1.5% to 2.0%, from 2.0% to 2.5%, from 2.5% to 3.0%, from 3.0% to 3.5%, from 3.5% to 4.0%, about 1%, about 1.5%, about 2%, about 2.5%, about 3%, about 3.5%, about 4%, about 4.5%, and about 5%.

The H₂O₂ bleaching solution may include buffers to help achieve and maintain specific pH ranges. Exemplary buffers include citrate, tris (hydroxymethyl) aminomethane (“Tris”), phosphate buffers, and the like. Unless stated otherwise, a recited pH of a solution shall refer to the pH of the solution when measured at 20° C. The pH of the aqueous solution is generally higher than pH 4, and typically is at least pH 7 (such as, for example pH 7.4 or higher) and may be as high as pH 9 or even higher. Exemplary pH ranges that are expressly contemplated include pH 7 to pH 9, pH 7.4 to pH 9, pH 7 to pH 8, and pH 8 to pH 9. In an exemplary embodiment, the aqueous environment comprises a Tris buffer in the range of 5 mM to 250 mM and has a pH in the range of 7.0 to 9. In another exemplary embodiment, the aqueous environment comprises from 5 mM to 75 mM Tris and a pH in the range 7.0 to 8.0. In another exemplary embodiment, the aqueous environment comprises from 75 mM to 250 mM Tris and has a pH in the range 7.0 to 8.5. In another exemplary embodiment, the aqueous environment comprises from 7.5 mM to 175 mM Tris and has a pH in the range of 7.9 to 8.8. In another exemplary embodiment, the aqueous environment comprises from 0 mM to 170 mM Tris and has a pH in the range of 7.0 to 8.8. In another exemplary embodiment, the aqueous environment comprises from 10 mM to 70 mM Tris and has a pH in the range of 7.7 to 8.6. In another exemplary embodiment, the aqueous environment comprises from 20 mM to 80 mM Tris and has a pH in the range of 7.9 to 9.0. In another exemplary embodiment, the aqueous environment comprises from 30 mM to 90 mM Tris and has a pH in the range of 8.0 to 8.7. In another exemplary embodiment, the aqueous environment comprises from 50 mM to 110 mM Tris and has a pH in the range of 8.0 to 8.8. In another exemplary embodiment, the aqueous environment comprises from 100 mM to 160 mM Tris and has a pH in the range of 8.2 to 8.9. In another exemplary embodiment, the aqueous environment comprises from 150 mM to 200 mM Tris and has a pH in the range of 8.3 to 8.9.

The incubation is generally performed at a temperature less than 65° C. (typically 55° C. or less, more typically at 50° C. or less) for up to 180 minutes. The precise amount of time selected will depend on the concentration of H₂O₂ and the incubation temperature, with higher concentrations and temperatures both permitting shorter time period. At 65° C. and above and at 180 minutes and above, the H₂O₂ bleaching solution have an unacceptable tendency to cause morphological damage and sample loss. At 55° C., the H₂O₂ bleaching solution generally results in acceptable morphology and bleaching, but still has a tendency to cause tissue loss and some morphological damage. At 50° C. and lower, the H₂O₂ bleaching solution generally results in acceptable morphology and bleaching with little tissue loss or morphological damage.

In an exemplary embodiment, the temperature is selected between 20° C. and 55° C. This temperature range generally allows for acceptable depigmentation to permit immunohistochemical analysis with a DAB stain without causing unacceptable morphological damage or sample loss. Within this range, lower temperatures require longer incubation times and result in less depigmentation, while higher temperatures tend to require shorter incubations and increase the extent of depigmentation while having a greater risk of causing morphological damage and sample loss.

In another exemplary embodiment, the temperature is from 37° C. to 50° C. Within this temperature range, the extent of depigmentation (as measured by melanin intensity and melanin percent coverage) is improved relative to 20° C. and the incidence of morphological damage and sample loss is reduced relative to 55° C.

In another exemplary embodiment, the temperature is from 37° C. to 45° C. Within this temperature range, the extent of depigmentation (as measured by melanin intensity and melanin percent coverage) is improved relative to 20° C., while the extent of morphological damage and sample loss is further improved relative to 55° C.

In another embodiment, the temperature is from about 37° C. to about 45° C. and the time is from 8 minutes to 180 minutes. In another embodiment, from about 37° C. to about 45° C. and the time is from 60 minutes to 180 minutes. In another embodiment, the H₂O₂ bleaching solution comprises from 2% to 4% H₂O₂ and up to 250 mM Tris at a pH in the range of 7.0 to 8.5, the temperature is in the range from about 37° C. to about 45° C. and the time is from 60 minutes to 180 minutes. In another embodiment, the H₂O₂ bleaching solution comprises from 2% to 4% H₂O₂ and up to 250 mM Tris at a pH in the range of 7.0 to 8.5, the temperature is in the range from about 37° C. to about 45° C. and the time is from 60 minutes to 95 minutes. In another embodiment, the H₂O₂ bleaching solution comprises about 2.5% H₂O₂ and up to 250 mM Tris at a pH in the range of 7.0 to 8.5, the temperature is in the range from about 37° C. to about 45° C. and the time is from 60 minutes to 180 minutes. In yet another embodiment, the H₂O₂ bleaching solution comprises from about 2.5% H₂O₂ and about 75 mM Tris at a pH of about 8, the temperature is in the range from 37° C. to 45° C. and the time is from 60 minutes to 95 minutes.

In the context of pH, the term “about” shall be interpreted to mean a pH that, when rounded to the hundredths position (according to NCES Standard 5-3), is within 5% of the recited pH. For example, a pH of “about 7” should include any pH within pH 7±0.35.

In the context of concentrations, the term “about” shall be interpreted to mean a concentration that, when rounded to the hundredths position in the same units of measurement (according to NCES Standard 5-3), is within 10% of the recited concentration. For example, a concentration of “about 100 mM” should include any concentration that rounds to within 100 mM+10 mM. Likewise, a concentration of “about 7.5% w/w” shall be interpreted to mean 7.5% w/w+0.75%.

In the context of temperature, the term “about” shall be interpreted to mean a temperature that, when rounded to the hundredths position in the same units of measurement (according to NCES Standard 5-3), is within 5% of the recited temperature. For example, a temperature of “about 55° C.” should include any concentration that rounds to within 55° C.±2.75° C.

### C. Optional Wash Step

The depigmentation method may optionally include one or more wash steps during the incubation period. During the wash step, the H₂O₂ bleaching solution is removed from the sample and a wash buffer is deposited on the sample and incubated for a relatively short period of time. The wash buffer is then removed from the sample and a new aliquot of H₂O₂ bleaching solution is deposited on the sample. When a wash step is included, the time occupied by the wash step is considered a part of the incubation period.

Wash buffers typically are neutrally-buffered saline solutions, which may also contain small amounts of detergent. Exemplary wash buffers include, for example, Phosphate Buffered Saline (PBS), PBS-Tween20, Tris Buffered Saline (TBS), TBS-Tween20 (polysorbate 20), Tris-HCl, Tris-HC-Tween20, Phosphate Buffer (PB), AP Buffer, and the like.

### III. Automated Affinity Staining Device and Method

The present depigmentation methods are especially useful for automated affinity histochemical or cytochemical methods of staining cellular samples (referred to collectively as “affinity staining”). Examples of affinity staining techniques include immunohistochemistry (IHC) and in situ hybridization (ISH). Affinity staining techniques typically involve contacting a sample deposited on a slide or other solid support with a biomarker-specific reagent under conditions sufficient to permit specific binding between the biomarker-specific reagent and the biomarker of interest. Binding of the biomarker-specific reagent to the biomarker facilitates deposition of a detectable moiety on the sample in proximity to locations containing the biomarker. The detectable moiety can be used to locate and/or quantify the biomarker to which the biomarker-specific reagent is directed. Thereby, the presence and/or concentration of the target in a sample can be detected by detecting the signal produced by the detectable moiety.

Automated affinity stainers typically include at least: reservoirs of the various reagents used in the staining protocols, a reagent dispense unit in fluid communication with the reservoirs for dispensing reagent to onto a slide, a waste removal system for removing used reagents and other waste from the slide, and environmental control system(s) for adjusting environmental factors (such as temperature, humidity, and/or pressure), and a control system that coordinates the actions of the reagent dispense unit, waste removal system, and the environmental control system(s). In addition to performing staining steps, many automated affinity histochemical stainers can also perform steps ancillary to staining (or are compatible with separate systems that perform such ancillary steps), including: slide baking (for adhering the sample to the slide), dewaxing (also referred to as deparaffinization), antigen retrieval, counterstaining, dehydration and clearing, and coverslipping. Prichard, Overview of Automated Immunohistochemistry, Arch Pathol Lab Med., Vol. 138, pp. 1578-1582 (2014), incorporated herein by reference in its entirety, describes several specific examples of automated IHC/ISH slide stainers and their various features, including the INTELLIPATH (Biocare Medical), WAVE (Celerus Diagnostics), DAKO OMNIS and DAKO AUTOSTAINER LINK 48 (Agilent Technologies), BENCHMARK (Ventana Medical Systems, Inc.), LEICA BOND, and LAB VISION AUTOSTAINER (Thermo Scientific) automated slide stainers. Additionally, Ventana Medical Systems, Inc. is the assignee of a number of United States patents disclosing systems and methods for performing automated analyses, including U.S. Pat. Nos. 5,650,327, 5,654,200, 6,296,809, 6,352,861, 6,827,901 and 6,943,029, and U.S. Published Patent Application Nos. 20030211630 and 20040052685, each of which is incorporated herein by reference in its entirety. Commercially-available staining units typically operate on one of the following principles: (1) open individual slide staining, in which slides are positioned horizontally and reagents are dispensed as a puddle on the surface of the slide containing a tissue sample (such as implemented on the DAKO AUTOSTAINER Link 48 (Agilent Technologies) and INTELLIPATH (Biocare Medical) stainers); (2) liquid overlay technology, in which reagents are either covered with or dispensed through an inert fluid layer deposited over the sample (such as implemented on BENCHMARK and DISCOVERY stainers (Roche)); (3) capillary gap staining, in which the slide surface is placed in proximity to another surface (which may be another slide or a coverplate) to create a narrow gap, through which capillary forces draw up and keep liquid reagents in contact with the samples (such as the staining principles used by DAKO TECHMATE, LEICA BOND, and DAKO OMNIS stainers). Some iterations of capillary gap staining do not mix the fluids in the gap (such as on the DAKO TECHMATE and the LEICA BOND). In variations of capillary gap staining termed dynamic gap staining, capillary forces are used to apply sample to the slide, and then the parallel surfaces are translated relative to one another to agitate the reagents during incubation to effect reagent mixing (such as the staining principles implemented on DAKO OMNIS slide stainers (Agilent)). In translating gap staining, a translatable head is positioned over the slide. A lower surface of the head is spaced apart from the slide by a first gap sufficiently small to allow a meniscus of liquid to form from liquid on the slide during translation of the slide. A mixing extension having a lateral dimension less than the width of a slide extends from the lower surface of the translatable head to define a second gap smaller than the first gap between the mixing extension and the slide. During translation of the head, the lateral dimension of the mixing extension is sufficient to generate lateral movement in the liquid on the slide in a direction generally extending from the second gap to the first gap. See WO 2011-139978 A1. It has recently been proposed to use inkjet technology to deposit reagents on slides. See WO 2016-170008 A1. This list of staining technologies is not intended to be comprehensive, and any fully or semi-automated system for performing biomarker staining may be incorporated into the histochemical staining platform.

When implemented on an automated affinity stainer, the H₂O₂ bleaching solution may be stored as a consumable on the device (such as in a reservoir in fluid communication with a dispenser). However, the relatively low concentrations of H₂O₂ in the H₂O₂ bleaching solution may not be sufficiently stable for long term storage on the device. Therefore, it may be typical to generate the H₂O₂ bleaching solution in situ from a set of stock solutions on the device. Thus, for example, the device may comprise a reservoir of a concentrated H₂O₂ stock solution and a reservoir of a buffer solution. The stock solutions are then mixed on the device to form the H₂O₂ bleaching solution.

For example, a stock buffer solution (such as a Tris-based buffer solution, a citrate-based buffer solution, or a phosphate-based buffer solution) may be deposited on the sample and then the concentrated H₂O₂ stock solution is diluted into the stock buffer solution on the sample to obtain the H₂O₂ bleaching solution. The depigmenting process then proceeds as described above.

In another example, the device comprises a stock buffer solution, a stock concentrated H₂O₂ solution, and a stock pH adjust solution. As used herein, a “pH adjust solution” is a solution that may be used to adjust the pH of another solution. Examples include buffered solutions (such as Tris-buffered solutions, citrate-buffered solutions, or phosphate-buffered solutions) at a defined pH (such as pH 9). The stock buffer solution, stock concentrated H₂O₂ solution, and a stock pH adjust solution are deposited on the sample to obtain the H₂O₂ bleaching solution. The depigmenting process then proceeds as described above.

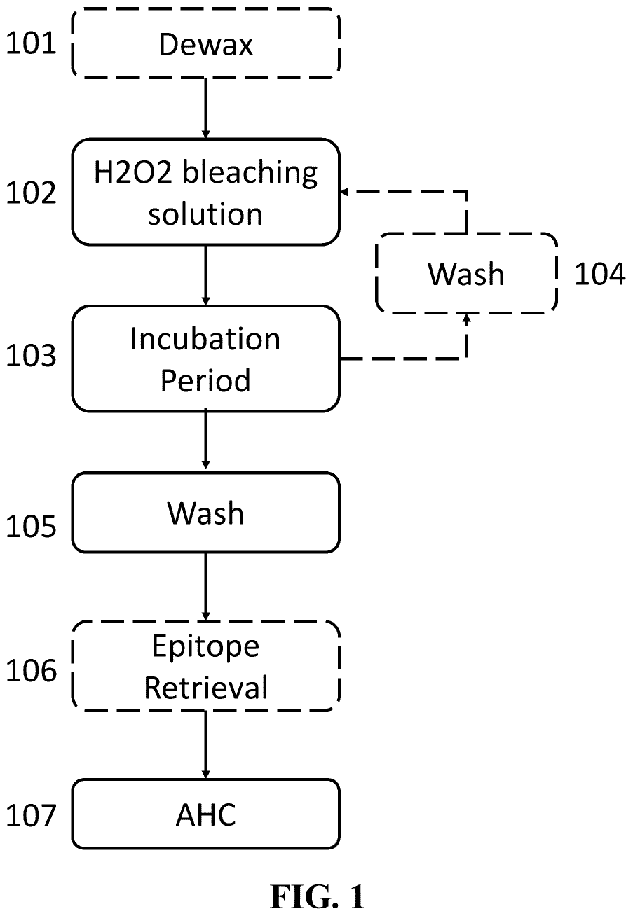

FIG. 1 illustrates an exemplary automated affinity staining workflow using stock solutions.

### A. Dewaxing

Where the sample is in a wax block (such as paraffin-embedded samples, including formalin-fixed, paraffin-embedded (FFPE) tissue samples)), a dewaxing step 101 is performed before the depigmentation method. Some automated affinity stainers are capable of performing dewaxing steps on the device. In such a case, the wax-embedded sample is placed directly on the device and a dewaxing procedure (such as a deparaffinization process) is performed before the depigmentation method. Otherwise, the dewaxing step is performed off of the device and the dewaxed sample is placed on the device. With other sample types (such as frozen sections), the dewaxing step may be omitted.

B. Stock Solution and H₂O₂ Bleaching Solution Formation

The stock solutions (including a stock buffer solution, the stock concentrated H₂O₂ solution, and optionally a pH adjust solution) are mixed together on the slide to obtain the H₂O₂ bleaching solution 102. In an embodiment, the stock concentrated H₂O₂ solution comprises from 4% to 20% H₂O₂ in a diluent selected from the group consisting of a water, a Tris-based aqueous buffer, a citrate-based aqueous buffer, or a phosphate-based aqueous buffer. In another embodiment, the stock concentrated H₂O₂ solution is from 4% to 20% H₂O₂ in water. In another embodiment, the stock concentrated H₂O₂ solution is from 5% to 20% H₂O₂ in water. In another embodiment, the stock concentrated H₂O₂ solution is from 10% to 20% H₂O₂ in water. In another embodiment, the stock concentrated H₂O₂ solution is from 5% to 15% H₂O₂ in water. In another embodiment, the stock concentrated H₂O₂ solution is from 10% to 15% H₂O₂ in water. In another embodiment, the stock concentrated H₂O₂ solution comprises from 4% to 20% H₂O₂ and from 0 to 75 mM Tris. In another embodiment, the stock concentrated H₂O₂ solution comprises from 5% to 20% H₂O₂ and from 0 to 75 mM Tris. In another embodiment, the stock concentrated H₂O₂ solution comprises from 10% to 20% H₂O₂ and from 0 to 75 mM Tris. In another embodiment, the stock concentrated H₂O₂ solution comprises from 5% to 15% H₂O₂ and from 0 to 75 mM Tris. In another embodiment, the stock concentrated H₂O₂ solution comprises from 10% to 15% H₂O₂ and from 0 to 75 mM Tris. In another embodiment, the stock concentrated H₂O₂ solution comprises from 4% to 20% H₂O₂ and from 10 to 75 mM Tris. In another embodiment, the stock concentrated H₂O₂ solution comprises from 5% to 20% H₂O₂ and from 10 to 75 mM Tris. In another embodiment, the stock concentrated H₂O₂ solution comprises from 10% to 20% H₂O₂ and from 10 to 75 mM Tris. In another embodiment, the stock concentrated H₂O₂ solution comprises from 5% to 15% H₂O₂ and from 10 to 75 mM Tris. In another embodiment, the stock concentrated H₂O₂ solution comprises from 10% to 15% H₂O₂ and from 10 to 75 mM Tris. In an embodiment, the foregoing stock concentrated H₂O₂ solutions are used with a stock buffer solution comprising from 10 to 100 mM Tris. In another embodiment, the foregoing stock concentrated H₂O₂ solutions are used with a stock buffer solution comprising from 10 to 100 mM Tris and a stock pH adjust solution comprising from 50 to 500 mM Tris.

C. Incubation Period with Optional Wash Steps

A heating source may then be activated if needed to obtain the temperatures and time periods described in Section II (referred to as the incubation period 103). One or more optional wash and replenish cycles 104 may be performed during the incubation period 103 by removing the H₂O₂ bleaching solution, washing the sample with a wash buffer, then regenerating the H₂O₂ bleaching solution as described at 102. At the end of the incubation period 103, the H₂O₂ bleaching solution is washed off with a wash buffer 105. Wash buffers typically are neutrally-buffered saline solutions, which may also contain small amounts of detergent. Exemplary wash buffers include, for example, Phosphate Buffered Saline (PBS), PBS-Tween20, Tris Buffered Saline (TBS), TBS-Tween20 (polysorbate 20), Tris-HCl, Tris-HC-Tween20, Phosphate Buffer (PB), AP Buffer, and the like.

### D. Affinity Stain

Where the biomarker-specific reagent is an antibody or an antibody-like specific detection reagent, an epitope-retrieval process 106 (also called antigen retrieval) may need to be performed. Exemplary epitope retrieval processes include: heat-induced epitope retrieval (HIER), which involves heating the sample in various buffers at different pH levels; protease-based epitope retrieval (PBER), in which samples are digested by proteolytic enzymes prior to staining; and combinations of HIER and PBER. Various specific epitope retrieval processes are reviewed by Shi et al., D'Amico et al., Yamashita et al., Vinod et al., and Warford et al., although this is not exhaustive. Whether to perform epitope retrieval and the particular form of epitope retrieval to use depends on the specific biomarker-specific reagent selected and may need to be empirically determined for each biomarker-specific reagent used. The depigmentation method is typically performed before any an epitope retrieval steps.

After epitope retrieval 106, detection reagents (including biomarker-specific reagents) are applied to affinity stain the sample 107. In a specific embodiment, the detection reagents are for performing an immunohistochemical stain with DAB as the detectable moiety. In another example, the sample is a melanoma sample; the biomarker-specific reagent is an antibody against a biomarker selected from the group consisting of LAG3, AXL, TIM3, FAP, CD8, PD-1, PD-L1, SOx 10, MARTI/MelanA, PRAME, HMB45, or CD8; and the detection reagents deposit a chromogenic agent (such as DAB).

Non-limiting examples of commercially available detection reagents or kits comprising detection reagents suitable for use with present methods include: VENTANA ULTRAVIEW detection systems (secondary antibodies conjugated to enzymes, including HRP and AP); VENTANA IVIEW detection systems (biotinylated anti-species secondary antibodies and streptavidin-conjugated enzymes); VENTANA OPTIVIEW detection systems (anti-species secondary antibody conjugated to a hapten and an anti-hapten tertiary antibody conjugated to an enzyme multimer); VENTANA Amplification kit (unconjugated secondary antibodies, which can be used with any of the foregoing VENTANA detection systems to amplify the number of enzymes deposited at the site of primary antibody binding); VENTANA OPTIVIEW amplification system (Anti-species secondary antibody conjugated to a hapten, an anti-hapten tertiary antibody conjugated to an enzyme multimer, and a tyramide conjugated to the same hapten. In use, the secondary antibody is contacted with the sample to effect binding to the primary antibody. Then the sample is incubated with the anti-hapten antibody to effect association of the enzyme to the secondary antibody. The sample is then incubated with the tyramide to effect deposition of additional hapten molecules. The sample is then incubated again with the anti-hapten antibody to effect deposition of additional enzyme molecules. The sample is then incubated with the detectable moiety to effect dye deposition); VENTANA DISCOVERY, DISCOVERY OMNIMAP, DISCOVERY ULTRAMAP anti-hapten antibody, secondary antibody, chromogen, fluorophore, and dye kits, each of which are available from Ventana Medical Systems, Inc. (Tucson, Arizona); POWERVISION and POWERVISION+IHC Detection Systems (secondary antibodies directly polymerized with HRP or AP into compact polymers bearing a high ratio of enzymes to antibodies); and DAKO ENVISION+System (enzyme labeled polymer that is conjugated to secondary antibodies). In a specific embodiment, the

If desired, the affinity stain 107 may also include a counterstain to assist in identifying morphologically relevant areas. Examples of counterstains include chromogenic nuclear counterstains, such as hematoxylin (stains from blue to violet), Methylene blue (stains blue), toluidine blue (stains nuclei deep blue and polysaccharides pink to red), nuclear fast red (also called Kernechtrot dye, stains red), and methyl green (stains green); non-nuclear chromogenic stains, such as cosin (stains pink); fluorescent nuclear stains, including 4′, 6-diamino-2-pheylindole (DAPI, stains blue), propidium iodide (stains red), Hoechst stain (stains blue), nuclear green DCS1 (stains green), nuclear yellow (Hoechst S769121, stains yellow under neutral pH and stains blue under acidic pH), DRAQ5 (stains red), DRAQ7 (stains red); fluorescent non-nuclear stains, such as fluorophore-labelled phalloidin, (stains filamentous actin, color depends on conjugated fluorophore).

### V. EXAMPLES

### Example 1: Levers of Hydrogen Peroxide Bleaching Process

Various depigmentation conditions were evaluated to identify the main drivers of the bleaching process. Melanoma tissue was used as a model system. Formalin-fixed, paraffin-embedded multi-tissue blocks (MTB) were generated, each including 4 melanoma cases and 1 non-neoplastic tonsil case.

5 variables were tested for their influence on depigmentation in melanoma tissue: (A) buffer composition [10 mM Tris and phosphate buffered saline (PBS)]; (B) pH [pH 4, 7.4, or 9]; (C) H₂O₂ concentration [1%, 10%, or 20% (w/w)]; (D) incubation temperature [37° C., 65° C., or 100° C.]; and (E) incubation duration [8 minutes, 48 minutes, or 92 minutes].

The stock H₂O₂ solutions were obtained by diluting a 30% (w/w) solution in deionized water to either 1%, 10%, or 20%. The final concentration was confirmed by titration with either a potassium permanganate solution or a cerium (IV) sulfate solution. The diluted solutions were loaded into a reagent dispenser compatible with a BENCHMARK ULTRA automated slide stainer.

A BENCHMARK ULTRA automated slide stainer was programmed to perform the protocols set forth in Table 1.

TABLE 1

| Parameter | No Bleach + NRC | No Bleach + LAG3 | Bleach + NRC | Bleach + LAG3 |
|---|---|---|---|---|
| Deparaffinization | Selected | Selected | Selected | Selected |
| Bleaching | Not Selected | Not Selected | Selected; Conditions selected | Selected; Conditions selected |
| | | | per Table 3 | per Table 3 |
| Cell Conditioning | 64 minutes CC1, 100° C. | 64 minutes CC1, 100° C. | 64 minutes CC1, 100° C. | 64 minutes CC1, 100° C. |
| (CC1) | | | | |
| Pre-Primary | Selected | Selected | Selected | Selected |
| Peroxidase Inhibitor | | | | |
| Antibody | Rabbit Monoclonal Ig Control | LAG3 (SP464) 32 minutes, | Rabbit Monoclonal Ig Control | LAG3 (SP464) 32 minutes, |
| | 32 minutes, 36° C. Or | 36° C. Or LAG3 (17B4) | 32 minutes, 36° C. Or | 36° C. Or LAG3 (17B4) |
| | Negative Control Mouse Ig | 16 minutes, 36° C. | Negative Control Mouse Ig | 16 minutes, 36° C. |
| | 16 minutes, 36° C. | | 16 minutes, 36° C. | |
| OPTIVIEW HQ | 8 minutes (default) | 8 minutes (default) | 8 minutes (default) | 8 minutes (default) |
| Universal Linker | | | | |
| OPTIVIEW HRP | 8 minutes (default) | 8 minutes (default) | 8 minutes (default) | 8 minutes (default) |
| Multimer | | | | |
| Counterstain: | 4 minutes | 4 minutes | 4 minutes | 4 minutes |
| Hematoxylin II | | | | |
| Post Counterstain: | 4 minutes | 4 minutes | 4 minutes | 4 minutes |
| Bluing Reagent | | | | |

The “Bleaching” protocol involved the following steps: (1) dispense a buffer puddle [REACTION BUFFER (Roche)] onto the slide; (2) dispense the H₂O₂ into the puddle at approximately a 3:1 v/v ratio of buffer: H₂O₂ for final H₂O₂ concentrations of 0.25%, 2.5%, or 5%; (3) dispense a liquid coverslip over the puddle; (4) incubate the sample at the recited temperature for the recited periods of time; and (5) wash the slide after the recited period of time.

Bleached slides were scored for overall melanin intensity, melanin coverage and non-specific background. Based on scores provided, each condition was given a rank of 1 to 5, 1 demonstrating the best bleaching performance and preservation of tissue integrity and 5 displaying the worst bleaching performance and/or preservation of tissue integrity. A description of each score is set forth at Table 2:

TABLE 2

| Ranking | Slide Condition | Description |
|---|---|---|
| 1 | Very good | Substantial to complete melanin reduction |
| | | and acceptable morphology |
| 2 | Good | Moderate melanin reduction and acceptable |
| | | morphology |
| 3 | Fair | Moderate melanin reduction and rare |
| | | morphological damage |
| 4 | Bad | Little melanin reduction and/or some |
| | | morphological damage/tissue loss |
| 5 | Worst | Little to no melanin reduction and/or severe |
| | | morphological damage/tissue loss |

All tested conditions and their associated scores are illustrated at Table 3:

TABLE 3

| | | | Stock | Temp | Time | |
|---|---|---|---|---|---|---|
| Condition | Buffer | pH | [H₂O₂] | (° C.) | (min) | Score |
| 1 | PBS | 9 | 20% | 100 | 92 | 5 |
| 2 | Tris | 4 | 1% | 100 | 92 | 5 |
| 3 | Tris | 9 | 20% | 37 | 92 | 1 |
| 4 | Tris | 4 | 20% | 100 | 8 | 3 |
| 5 | PBS | 9 | 1% | 100 | 8 | 3 |
| 6 | PBS | 4 | 20% | 65 | 92 | 5 |
| 7 | PBS | 7.4 | 1% | 37 | 92 | 3 |
| 8 | Tris | 9 | 10% | 65 | 92 | 5 |
| 9 | PBS | 7.4 | 20% | 37 | 8 | 4 |
| 10 | Tris | 9 | 20% | 65 | 8 | 2 |
| 11 | PBS | 4 | 1% | 65 | 48 | 3 |
| 12 | PBS | 4 | 10% | 37 | 48 | 3 |
| 13 | Tris | 9 | 1% | 37 | 48 | 4 |
| 14 | Tris | 7.4 | 20% | 65 | 48 | 4 |
| 15 | Tris | 7.4 | 1% | 100 | 48 | 5 |
| 16 | Tris | 9 | 10% | 37 | 8 | 4 |
| 17 | Tris | 7.4 | 1% | 65 | 92 | 3 |
| 18 | Tris | 7.4 | 10% | 100 | 8 | 4 |

Significant tissue loss was observed at the 100° C. incubation temperature and at the 92-minute incubation time. Bleaching performance was insufficient with the 1% H₂O₂ stock solution.

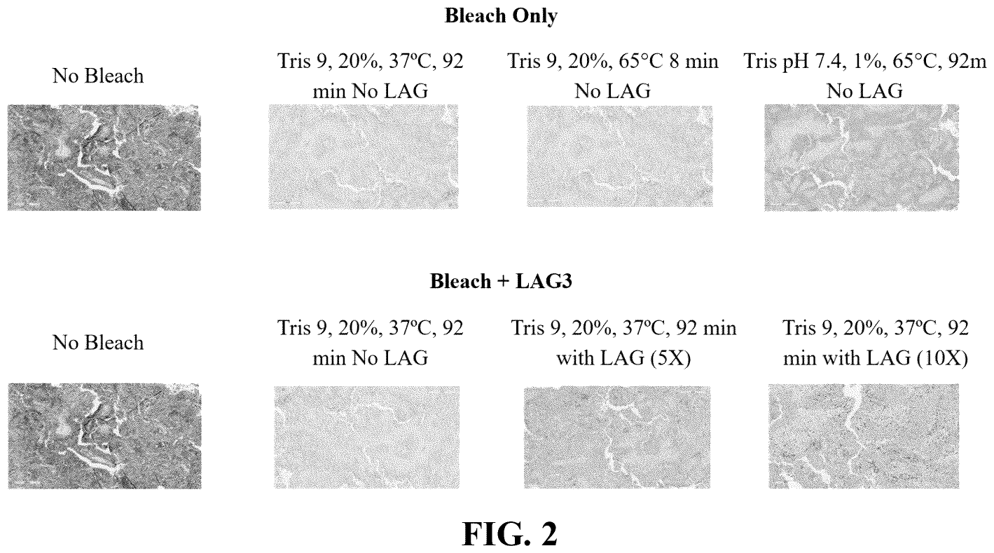

Conditions 3, 4, 10 and 17 produced sufficient bleaching without damaging the tissue morphology. Accordingly, samples depigmented under these conditions were immunohistochemically stained with a LAG3 monoclonal antibody (clone SP464; Ventana Medical Systems, Inc.). Representative images of IHC stained tissue are at FIG. 2. Condition 3 (Tris pH 9, 20% H₂O₂, 37° C., 92 min) produced the best results compared to other conditions tested: sufficient bleaching, epitope preservation with LAG3 stained slides was observed, and the morphology of the cells was undamaged by the bleaching process.

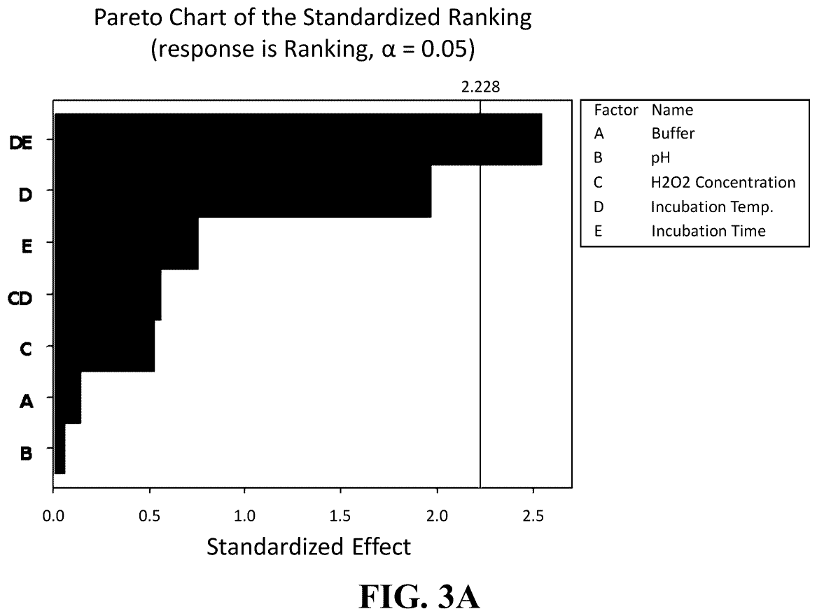

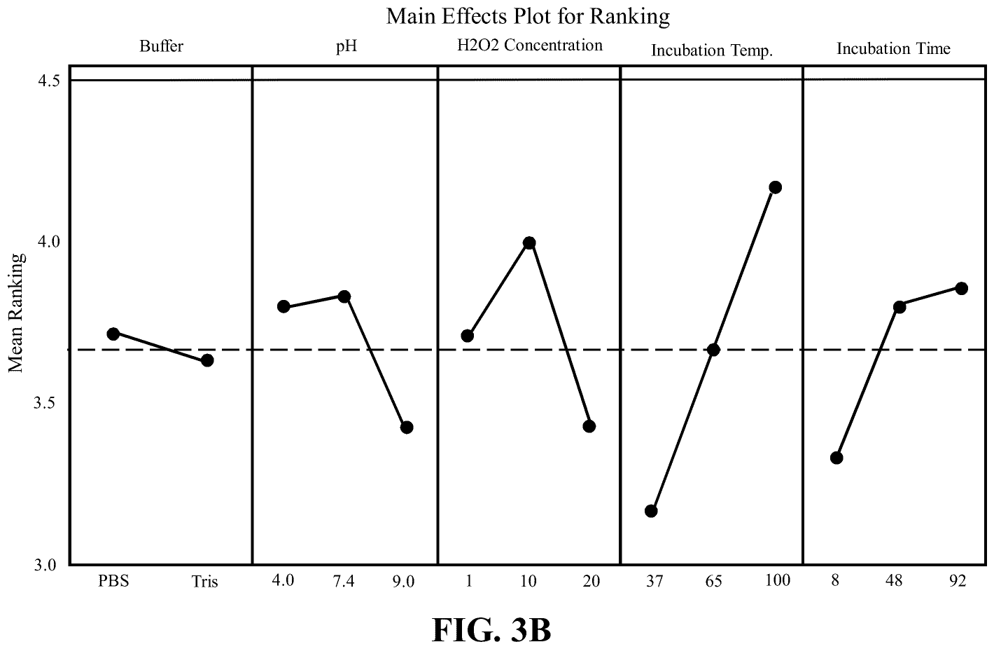

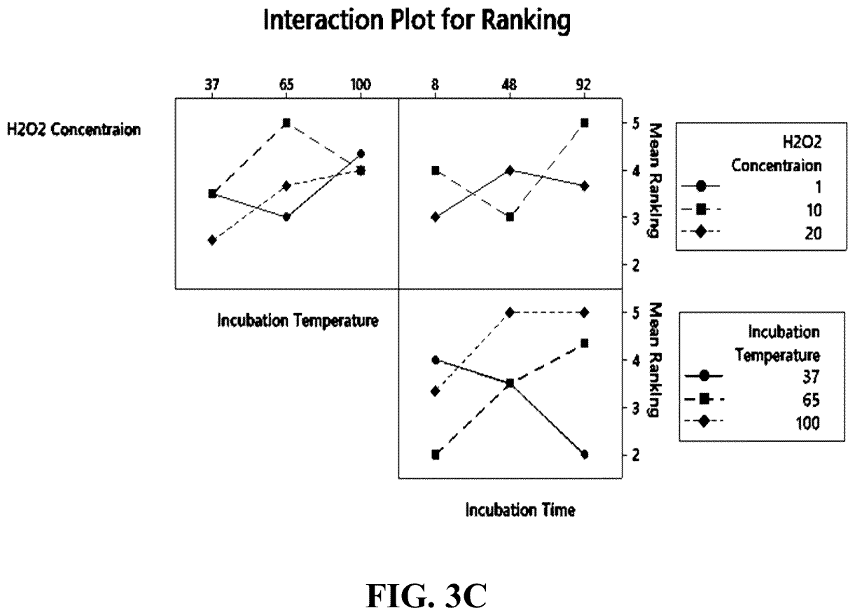

The rankings from Table 3 were analyzed in MINITAB 18 (Minitab, LLC) for impact on overall performance of the bleaching conditions. Results are shown at FIGS. 3A-3C. The combination of incubation time and temperature had the greatest impact on the overall performance (FIG. 3A). The bar for time and temperature combination (DE) crosses the reference line at 2.23 indicating that this factor is statistically significant at the 0.05 level with the current model terms. Increasing the time contributed to poor morphology, especially in combination with high temperature. Buffer and pH had the least impact to the overall performance relative to H₂O₂ concentration, time and temperature. The main effect plot in FIG. 3B illustrates that the composition of the buffers had the least impact to the overall performance and incubation temperature had the most impact. The bleaching performance appeared to be better at pH 9 compared to pH 4 and 7.4; H₂O₂ concentration of 20% produced the best bleaching compared to 1% and 10%. With increasing temperature and time, the bleaching performance worsened. As seen in the interaction plot in FIG. 3C, the higher H₂O₂ concentrations (10% and 20%) ranked best at lower temperature (37° C.), whereas the lower concentration (1%) ranked best at 65° C. Lower temperature (37° C.) was best ranked at longer time (92 min), whereas the performance was worse at moderate and high temperatures (65° C. and 100° C.).

### Example 2: 3×3×3 Concentration, Time, and Temperature Optimization

A 3×3×3 study was performed with the three factors and levels listed in Table 4.

TABLE 4

| Factors | Levels | Responses |
|---|---|---|
| H₂O₂ Concentration | 1%, 10%, 20% | Melanin Intensity, |
| | | % |
| Incubation Temperature | 37° C., 65° C., 100° C. | Melanin Coverage |
| Incubation Time | 8 min, 48 min, 92 min | |

The bleaching reagent was prepared by diluting H₂O₂ stock solution with 10 mM Tris (pH 9) to the desired testing concentration. A single MTB slide was bleached with each of the 27 conditions in Table 5, using the staining protocol of Table 5 and Tris (pH 9) as the buffer puddle.

TABLE 5

| Condition | H₂O₂ | Temperature | | Time | |
|---|---|---|---|---|---|
| 1 | 1% | 37° | C. | 8 | min |
| 2 | 1% | 37° | C. | 48 | min |
| 3 | 1% | 37° | C. | 92 | min |
| 4 | 1% | 65° | C. | 8 | min |
| 5 | 1% | 65° | C. | 48 | min |
| 6 | 1% | 65° | C. | 92 | min |
| 7 | 1% | 100° | C. | 8 | min |
| 8 | 1% | 100° | C. | 48 | min |
| 9 | 1% | 100° | C. | 92 | min |
| 10 | 10% | 37° | C. | 8 | min |
| 11 | 10% | 37° | C. | 48 | min |
| 12 | 10% | 37° | C. | 92 | min |
| 13 | 10% | 65° | C. | 8 | min |
| 14 | 10% | 65° | C. | 48 | min |
| 15 | 10% | 65° | C. | 92 | min |
| 16 | 10% | 100° | C. | 8 | min |
| 17 | 10% | 100° | C. | 48 | min |
| 18 | 10% | 100° | C. | 92 | min |
| 19 | 20% | 37° | C. | 8 | min |
| 20 | 20% | 37° | C. | 48 | min |
| 21 | 20% | 37° | C. | 92 | min |
| 22 | 20% | 65° | C. | 8 | min |
| 23 | 20% | 65° | C. | 48 | min |
| 24 | 20% | 65° | C. | 92 | min |
| 25 | 20% | 100° | C. | 8 | min |
| 26 | 20% | 100° | C. | 48 | min |
| 27 | 20% | 100° | C. | 92 | min |

BLANK

Additional slides bleached with conditions 6, 12-14, and 20-22 were stained for LAG3. 8.1.2.4 The ranking system described at Table 2 was used to analyze the data and generate plots in MINITAB 18.

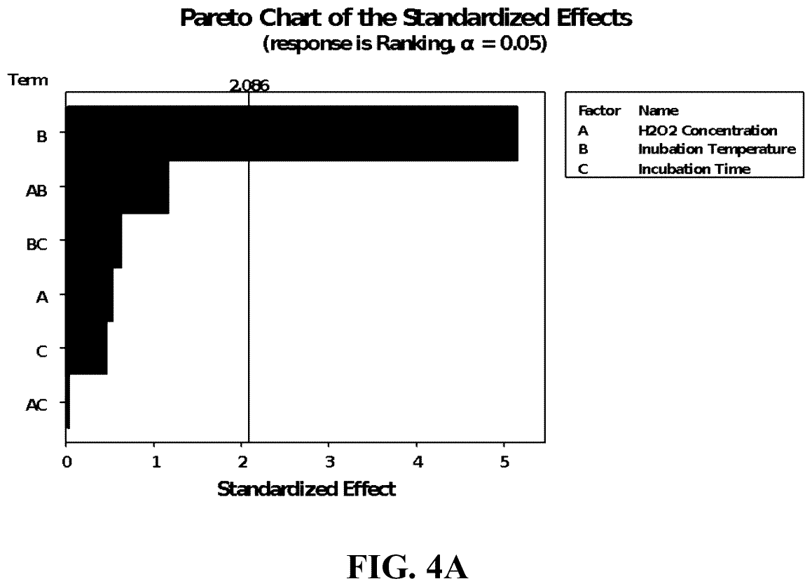

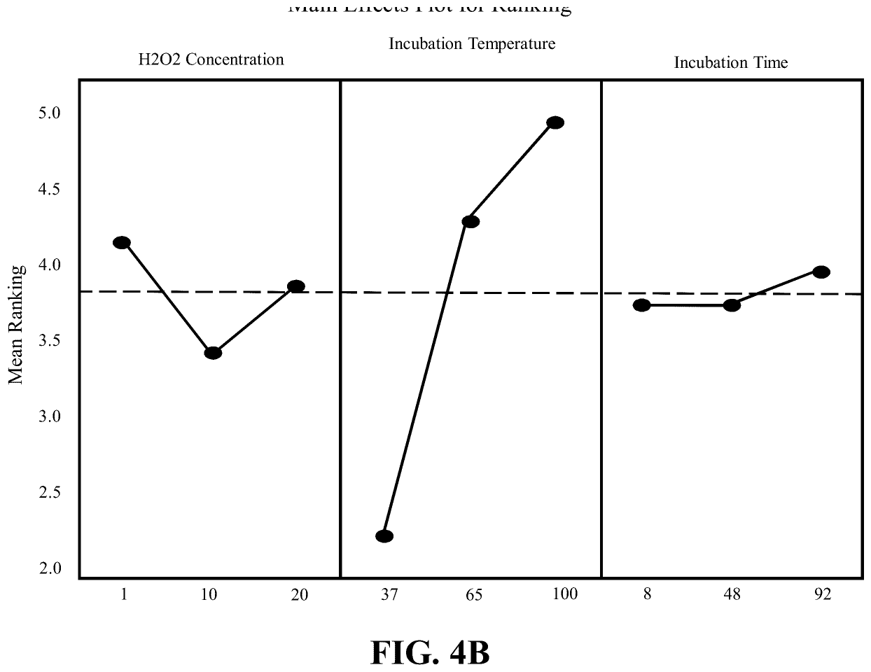

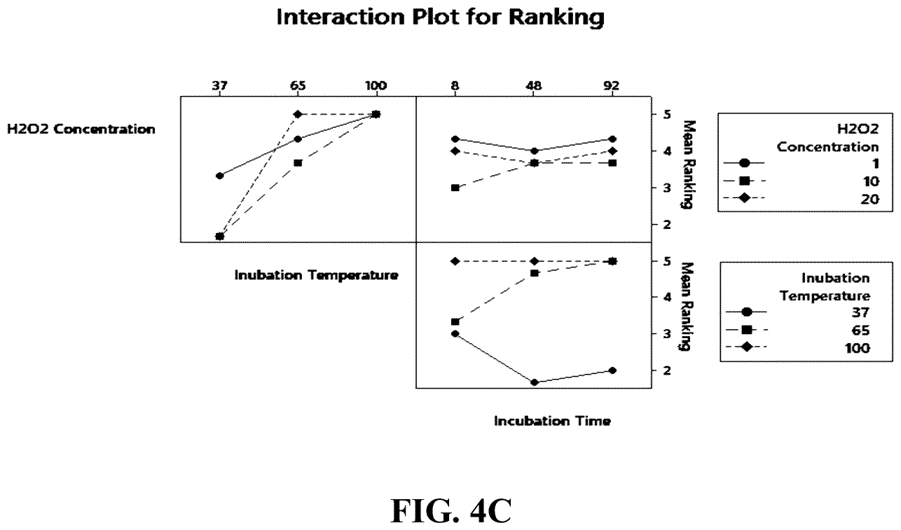

The Pareto chart at FIG. 4A demonstrates that the most impactful factor to overall performance is the incubation temperature. The bar for the temperature (B) crosses the reference line at 2.08 indicating that this factor is statistically significant at the 0.05 level with the current model terms. With increasing temperature, there was a corresponding increase in slide unacceptability due to morphological damage.

As seen in the main effect plot at FIG. 4B, bleaching performance was similar with all three concentrations of H₂O₂, with 10% producing slightly better ranking compared to 1% and 20%. The bleaching performance for all three incubation times was comparable. Incubation temperature had the highest impact on the performance with higher temperatures resulting in a worse ranking.

The interaction plot at FIG. 4C illustrates that lower temperature was consistently better ranked across concentrations, whereas high temperature ranked poorly across concentrations. The interaction of concentration with time was less steep than concentration compared to temperature. Higher temperatures performed poorly regardless of the time.

The results suggested that lower temperature was uniformly better. Moreover, the bleaching performance of 10% and 20% H₂O₂ was not significantly different; however, lower concentration (1%) did not produce sufficient bleaching.

### Example 3: Concentration and Time Optimization at 37° C. and 50° C.

The objective of this testing was to further optimize the H₂O₂ concentration and incubation times at lower temperatures (37° C. and 50° C.). The bleaching reagent was prepared by diluting H₂O₂ stock solution with 10 mM Tris (pH 9) to the desired testing concentration. A single MTB slide was bleached with each of the 48 conditions in Table 6, using the staining protocol of Table 1 and 10 mM Tris (pH 9) as the buffer puddle.

TABLE 6

| Condition | H₂O₂ | Temp. | Time |
|---|---|---|---|
| 1 | 5% | 37° C. | 56 min. |
| 2 | 5% | 37° C. | 64 min. |
| 3 | 5% | 37° C. | 80 min. |
| 4 | 5% | 37° C. | 92 min. |
| 5 | 5% | 50° C. | 56 min. |
| 6 | 5% | 50° C. | 64 min. |
| 7 | 5% | 50° C. | 80 min. |
| 8 | 5% | 50° C. | 92 min. |
| 9 | 6% | 37° C. | 56 min. |
| 10 | 6% | 37° C. | 64 min. |
| 11 | 6% | 37° C. | 80 min. |
| 12 | 6% | 37° C. | 92 min. |
| 13 | 6% | 50° C. | 56 min. |
| 14 | 6% | 50° C. | 64 min. |
| 15 | 6% | 50° C. | 80 min. |
| 16 | 6% | 50° C. | 92 min. |
| 17 | 7% | 37° C. | 56 min. |
| 18 | 7% | 37° C. | 64 min. |
| 19 | 7% | 37° C. | 80 min. |
| 20 | 7% | 37° C. | 92 min. |
| 21 | 7% | 50° C. | 56 min. |
| 22 | 7% | 50° C. | 64 min. |
| 23 | 7% | 50° C. | 80 min. |
| 24 | 7% | 50° C. | 92 min. |
| 25 | 8% | 37° C. | 56 min. |
| 26 | 8% | 37° C. | 64 min. |
| 27 | 8% | 37° C. | 80 min. |
| 28 | 8% | 37° C. | 92 min. |
| 29 | 8% | 50° C. | 56 min. |
| 30 | 8% | 50° C. | 64 min. |
| 31 | 8% | 50° C. | 80 min. |
| 32 | 8% | 50° C. | 92 min. |
| 33 | 9% | 37° C. | 56 min. |
| 34 | 9% | 37° C. | 64 min. |
| 35 | 9% | 37° C. | 80 min. |
| 36 | 9% | 37° C. | 92 min. |
| 37 | 9% | 50° C. | 56 min. |
| 38 | 9% | 50° C. | 64 min. |
| 39 | 9% | 50° C. | 80 min. |
| 40 | 9% | 50° C. | 92 min. |
| 41 | 10% | 37° C. | 56 min. |
| 42 | 10% | 37° C. | 64 min. |
| 43 | 10% | 37° C. | 80 min. |
| 44 | 10% | 37° C. | 92 min. |
| 45 | 10% | 50° C. | 56 min. |
| 46 | 10% | 50° C. | 64 min. |
| 47 | 10% | 50° C. | 80 min. |
| 48 | 10% | 50° C. | 92 min. |

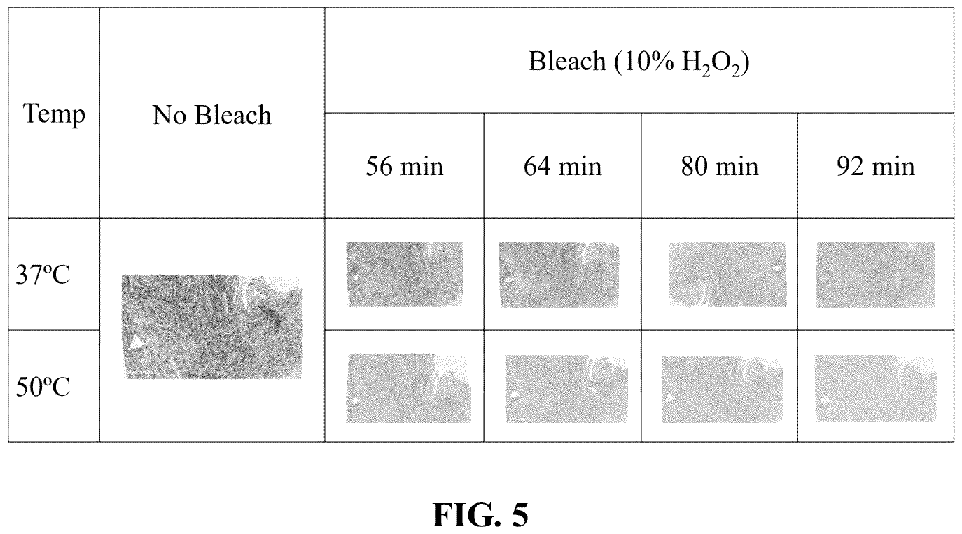

The bleaching performance produced by 10% H₂O₂ at 50° C. for 64 minutes was similar to 6% H₂O₂ at 50° C. for 80 minutes and 5% H₂O₂ at 50° C. for 92 minutes. Representative images from this testing are illustrated at FIG. 5.

10% H₂O₂ at 50° C. for 64 minutes produced sufficient bleaching with preservation of the morphology. However, relative to 37° C., the 50° C. condition resulted in nuclear damage in some tissues. This impact to tissue morphology at 50° C. was observed at 92 minutes for 5% H₂O₂ and 10% H₂O₂.

Samples bleached with 10% H₂O₂ at 37° C. for 92 minutes demonstrated substantial to complete reduction in melanin pigment on the highly pigmented MTB tissue case while preserving tissue morphology. The non-pigmented melanoma cases displayed concordant LAG3-immune cell staining with and without bleaching, confirming epitope preservation. Based on these results, 10% H₂O₂ incubated at 37° C. for 92 minutes was selected as the nominal bleaching condition for subsequent testing.

### Example 4: Evaluation of Additional Times and Temperatures

Our previous findings from Example 3 show that bleaching under the nominal condition (10% H₂O₂, 37° C., 92 minutes) facilitates the removal of melanin while preserving LAG3 expression of the tissues as well as the cellular morphology. In order to identify other potential conditions with efficient bleaching capability, a variety of conditions described in the literature were tested (Foss, McGovern, Shen, and Orchard (2007)). The bleaching performance (i.e., percentage of residual melanin, staining intensity of melanin), melanoma tissue morphology, and tonsil tissue morphology were evaluated and further compared to the reference (nominal) condition.

Four melanoma MTBs were used in further optimization of incubation time and temperature. Slides were bleached with the conditions listed in Table 7.

TABLE 7

| Condition | H₂O₂ (%) | Temperature (° C.) | Time (min) |
|---|---|---|---|
| 1 | 2 | 80 | 16 |
| 2 | 10 | 37 | 92 |
| 3 | 10 | 50 | 64 |
| 4 | 10 | 65 | 16 |
| 5 | 20 | 37 | 60 |
| 6 | 20 | 37 | 92 |
| 7 | 30 | 37 | 60 |

The bleaching reagent was prepared by diluting H₂O₂ stock solution with deionized water to the desired testing concentration. A single slide per MTB was bleached with each condition followed by IHC staining with LAG3 clone SP464 or the NRC. Acceptability was assessed retrospectively using the criteria outlined in Table 2. Results are shown in Table 8

TABLE 8

| MTB | Condition | Tissue 1 | Tissue 2 | Tissue 3 | Tissue 4 | Tonsil |
|---|---|---|---|---|---|---|
| MTB 1 | 1 | UA | UA | UA | A | A |
| | 2 | UA | UA | UA | A | A |
| | 3 | UA | UA | UA | A | A |
| | 4 | UA | UA | UA | A | A |
| | 5 | UA | UA | UA | A | A |
| | 7 | UA | UA | UA | A | A |
| MTB 2 | 1 | A | A | NE | A | A |
| | 2 | A | A | NE | A | A |
| | 3 | A | A | NE | A | A |
| | 4 | A | A | NE | A | A |
| | 5 | A | A | NE | A | A |
| | 7 | NE | A | NE | A | A |
| MTB 3 | 1 | A | A | UA | NE | A |
| | 2 | A | A | A | NE | A |
| | 3 | A | A | UA | NE | A |
| | 4 | A | A | UA | NE | A |
| | 5 | A | A | UA | NE | A |
| | 7 | A | A | UA | NE | A* |
| MTB 4 | 1 | N/E | N/E | N/E | N/E | N/E |
| | 2 | N/E | N/E | N/E | N/E | N/E |
| | 3 | N/E | N/E | N/E | N/E | N/E |
| | 4 | N/E | N/E | N/E | N/E | N/E |
| | 5 | N/E | N/E | N/E | N/E | N/E |
| | 7 | N/E | N/E | N/E | N/E | N/E |

*Indicates <1% (focal) morphological damage
UA: Unacceptable
A: Acceptable
N/E: Not Evaluable due to tissue loss or significant change in tissue size

All slides demonstrated sufficient bleaching that allowed for the interpretation of specific LAG3 DAB signal. Moreover, the antigenicity of the tissue was preserved in all slides. The overall bleaching performance and LAG3 signal was comparable to the nominal condition (10% H₂O₂ in DI Water, 37° C., 92 minutes).

Higher incubation temperature (50° C. and 65° C.) produced better bleaching performance; however, higher temperatures also had presented a higher incidence of minor to moderate morphological damage.

Slides bleached with 20% H₂O₂ at 37° C. for 60 minutes produced acceptable morphology relative to the nominal condition while slightly improving the bleaching performance. However, increasing the H₂O₂ concentration to 30% adversely affected the cellular morphology. The minimal improvement in bleaching performance observed at higher concentrations of H₂O₂ did not justify increasing H₂O₂ concentration of the nominal formulation.

### Example 5: Evaluation of Long Incubation Times

The objective of this study was to assess the upper limit of the bleaching incubation time and its impact on tissue morphology and counterstain acceptability. Three MTBs were stained in duplicate with NRC following the bleaching step to assess cellular morphology and counterstain performance. Two slides per MTB were bleached with 10% H₂O₂ diluted in DI water and incubated at 37° C. for the times indicated in Table 9. For each bleaching condition, slides were deemed unacceptable if there was loss of tissue integrity and/or nuclear damage as demonstrated by weak counterstain. In all cases, the duplicate slides were comparable to each other.

TABLE 9

| H₂O₂ Concentration | Incubation Temperature | Incubation Time | |
|---|---|---|---|
| 10% in DI Water | 37° C. | 92 | min |
| | | 120 | min |
| | | 180 | min |
| | | 240 | min |
| | | 300 | min |

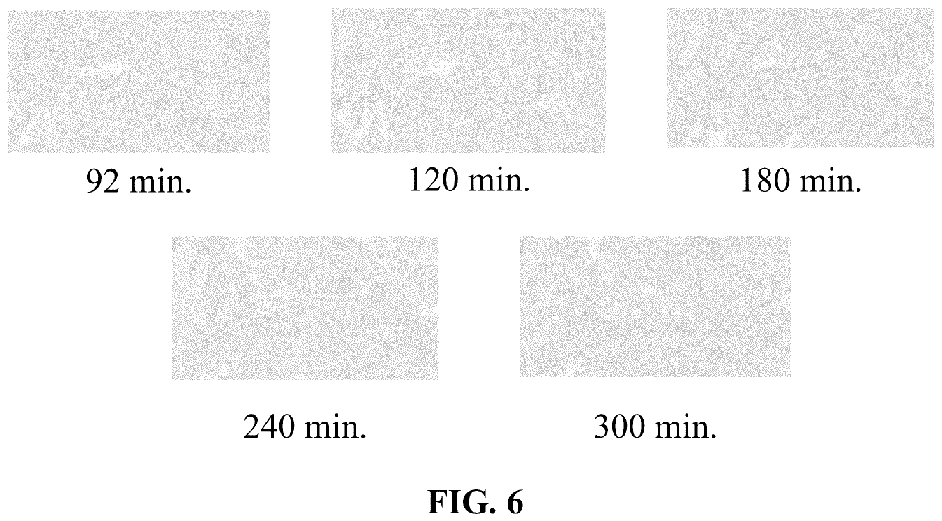

At 120 minutes, all tissues on all MTBs were acceptable and comparable to the nominal 92 minute condition. Morphological and/or counterstain unacceptability was observed in few cases in MTB's K and R at the 180 minute incubation time. By 240 minutes, all of the MTBs demonstrated tissue unacceptability in at least one tissue. At 300-minutes, nine out of ten tissues across the three MTBs displayed tissue unacceptability. See Table 10 for summary of the result from this study. Representative images are displayed in FIG. 6.

TABLE 10

| | Time | | | | | |
|---|---|---|---|---|---|---|
| MTB | (min) | Tissue 1 | Tissue 2 | Tissue 3 | Tissue 4 | Tonsil |
| 1 | 92 | Exhausted | Acceptable | Acceptable | Acceptable | Acceptable |
| | 120 | | Acceptable | Acceptable | Acceptable | Acceptable |
| | 180 | | Acceptable | Unacceptable | Acceptable | Unacceptable |
| | 240 | | Unacceptable | Unacceptable | Acceptable | Unacceptable |
| | 300 | | Unacceptable | Unacceptable | Acceptable | Unacceptable |
| 2 | 92 | Exhausted | Exhausted | Acceptable | Acceptable | Acceptable |
| | 120 | | | Acceptable | Acceptable | Acceptable |
| | 180 | | | Acceptable | Acceptable | Acceptable |
| | 240 | | | Unacceptable | Unacceptable | Unacceptable |
| | 300 | | | Unacceptable | Unacceptable | Unacceptable |
| 3 | 92 | Exhausted | Exhausted | Acceptable | Acceptable | Acceptable |
| | 120 | | | Acceptable | Acceptable | Acceptable |
| | 180 | | | Acceptable | Unacceptable | Acceptable |
| | 240 | | | Acceptable | Unacceptable | Acceptable |
| | 300 | | | Unacceptable | Unacceptable | Unacceptable |

### Example 6: Evaluation of Diluent Composition and Puddle Conditions

The objective of this testing was to compare Tris and PBS buffers to deionized water as a diluent for H₂O₂ to determine if the pH/buffering of the diluent impacts bleaching performance. The buffers were used as the diluent to achieve the alkalinity of the bleaching reaction. However, the concentration of H₂O₂ in the formulation is high (10% w/w, ˜3.2 M) which may dictate the pH of the formulated product. Therefore, to understand the pH of the formulated product, a pH measurement was performed by diluting 32% H₂O₂ to 10% with the desired diluent then measuring the pH using a pH meter. Results are shown at Table 11:

TABLE 11

| Formulation | Measured pH |
|---|---|
| 10% H₂O₂ in 10 mM Tris pH 9 | 7.89 |
| 10% H₂O₂ in 1X PBS pH 8 | 6.9 |
| 10% H₂O₂ in DI Water | 5.7 |

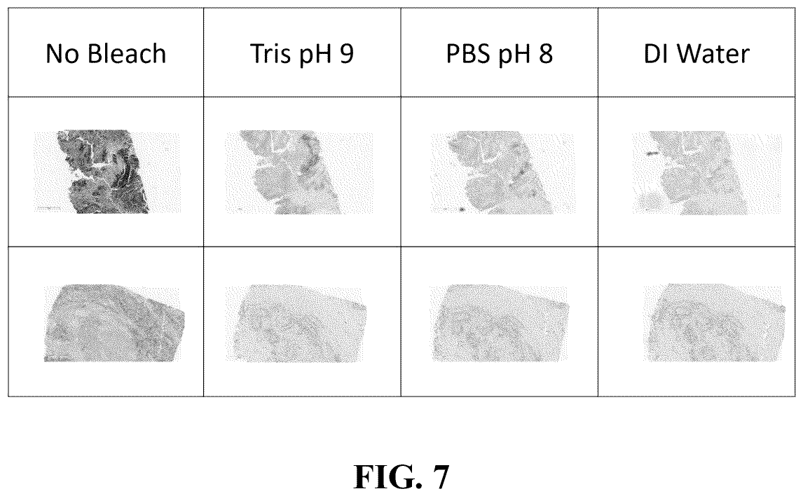

The pH analysis of H₂O₂ in 1×PBS and 10 mM Tris revealed that the high concentration of H₂O₂ is dictating the pH of the final bleaching reagent solution. Hence, buffers used as diluent were not performing within their respective buffering capacities and the H₂O₂ was driving the pH down from the alkaline range. Bleaching performance was similar across all formulations tested, see Table 12 for results summary and FIG. 7 for representative images. In all evaluable bleached slides, residual melanin had an overall intensity that allowed for interpretation of LAG3 specific staining. Moreover, LAG3 staining was concordant across all evaluable bleached slides. In sum, using water as a diluent for H₂O₂ produced similar results as other diluents.

TABLE 12

| | | Tissue | Tissue | Tissue | Tissue | |
|---|---|---|---|---|---|---|
| MTB | Diluent | 1 | 2 | 3 | 4 | Tonsil |
| 1 | 1X PBS pH 8 | N/A | A | A | A | A |
| | 10 mM Tris | | A | A | A | A |
| | pH 9 | | | | | |
| | DI Water | | A | A | A | A |
| 2 | 1X PBS pH 8 | A | A | A | A | A |
| | 10 mM Tris | A | A | A | A | A |
| | pH 9 | | | | | |
| | DI Water | NE | NE | NE | NE | NE |
| | DI Water | A | A | A | A | A |
| | (repeat) | | | | | |
| 3 | 1X PBS pH 8 | A | A | A | A | A |
| | 10 mM Tris | A | A | A | A | A |
| | pH 9 | | | | | |
| | DI Water | A | A | A | A | A |
| 4 | 1X PBS pH 8 | A | A | A | A | A |
| | 10 mM Tris | A | A | A | A | A |
| | pH 9 | | | | | |
| | DI Water | A | A | A | A | A |

The chemistry of the on-slide reaction puddle on the slide was then evaluated across various bleaching reagent formulations and with the application of a pH adjust buffer (high concentration Tris base in diH₂O at pH 9). The pH measurement of bleaching reagent diluents (1X PBS, 10 mM Tris, DI water, CC1, and Reaction Buffer), 10% H₂O₂ formulations in those diluents, and the puddle formulation (10% H₂O₂ in those diluents in a Reaction Buffer puddle; final ‘on-slide’ concentration of 2.5% H₂O₂) was performed at various temperatures.

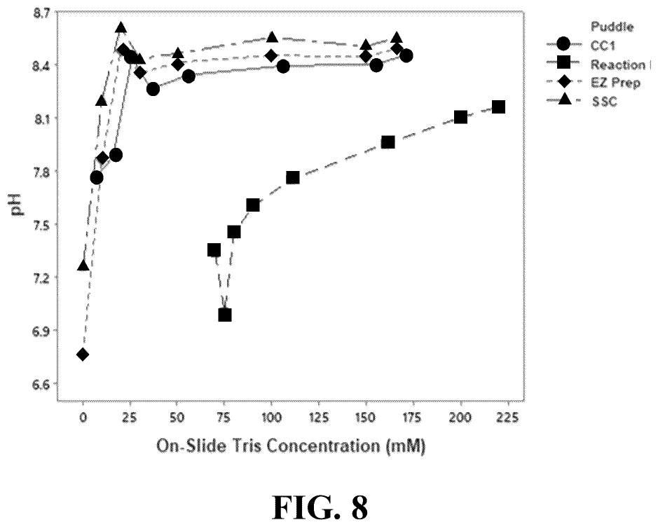

Non-automated bleaching procedures (such as those in Orchard (2007) and Chung) suggested that the alkalinity of the reaction solution can improve bleaching performance. Therefore, on-slide puddle compositions were replicated in an offline environment and pH was evaluated following the sequential application of a pH adjust buffer. Various formulations of H₂O₂ were prepared using DI water as diluent: 10% H₂O₂ without pH adjust served as reference, 12.5% H₂O₂ and 15% H₂O₂ were formulated for use with the sequential application of either a single or double application of a pH adjust buffer. The concentration of pH adjust buffer used in single dispense ranged from 50 mM to 500 mM Tris, and for the double application, 450 mM or 500 mM Tris was used. The final ‘on-slide’ concentration of all formulations was 2.5% H₂O₂. Results are shown at Table 13 and FIG. 8.

TABLE 13

| | | Final | | | |
|---|---|---|---|---|---|
| | | [Tris] of | Puddle | Puddle | Puddle |
| Bleaching | Puddle | puddle | pH at | pH at | pH at |
| Formulation | buffer | (mM) | RT | 37° C. | 50° C. |
| 10% H₂O₂ in | CC1 | 7.5 | 7.96 | 7.77 | 7.63 |
| water | Rxn Buffer | 75 | 7.42 | 7.04 | 6.76 |
| (no pH Adjust) | EZ Prep | 0 | 7.04 | 6.77 | 6.64 |
| | SSC | 0 | 7.20 | 7.25 | 7.24 |
| 12.5% H₂O₂ in | CC1 | 16 | 8.35 | 7.88 | 7.67 |
| water + 50 mM | Rxn Buffer | 70 | 7.71 | 7.34 | 7.04 |
| pTris H Adjust | EZ Prep | 10 | 8.46 | 7.86 | 7.68 |
| | SSC | 10 | 8.53 | 8.20 | 7.97 |
| 12.5% H₂O₂ in | CC1 | 26 | 8.77 | 8.44 | 8.19 |
| water + 100 mM | Rxn Buffer | 80 | 7.98 | 7.45 | 7.24 |
| Tris pH Adjust | EZ Prep | 20 | 8.92 | 8.48 | 8.29 |
| | SSC | 20 | 8.91 | 8.61 | 8.39 |
| 12.5% H₂O₂ in | CC1 | 36 | 8.61 | 8.26 | 8.03 |
| water + 150 mM | Rxn Buffer | 90 | 7.98 | 7.60 | 7.34 |
| Tris pH Adjust | EZ Prep | 30 | 8.60 | 8.35 | 8.10 |
| | SSC | 30 | 8.70 | 8.43 | 8.22 |
| 12.5% H₂O₂ in | CC1 | 56 | 8.63 | 8.34 | 8.06 |
| water + 250 mM | Rxn Buffer | 110 | 8.07 | 7.75 | 7.44 |
| Tris pH Adjust | EZ Prep | 50 | 8.71 | 8.41 | 8.13 |
| | SSC | 50 | 8.62 | 8.46 | 8.19 |
| 12.5% H₂O₂ in | CC1 | 106 | 8.70 | 8.39 | 8.11 |
| water + 500 mM | Rxn Buffer | 160 | 8.26 | 7.95 | 7.64 |
| Tris pH Adjust | EZ Prep | 100 | 8.74 | 8.45 | 8.16 |
| | SSC | 100 | 8.82 | 8.55 | 8.24 |
| 15% H₂O₂ in | CC1 | 155 | 8.68 | 8.40 | 8.12 |
| water + 450 mM | Rxn Buffer | 200 | 8.39 | 8.10 | 7.79 |
| Tris pH Adjust | EZ Prep | 150 | 8.75 | 8.44 | 8.16 |
| (double dispense) | SSC | 150 | 8.80 | 8.50 | 8.22 |
| 15% H₂O₂ in | CC1 | 171 | 8.77 | 8.45 | 8.17 |
| water + 500 mM | Rxn Buffer | 220 | 8.45 | 8.16 | 7.85 |
| Tris pH Adjust | EZ Prep | 166 | 8.79 | 8.49 | 8.19 |
| (double dispense) | SSC | 166 | 8.78 | 8.55 | 8.27 |

These results indicate that the addition of a pH adjust buffer to the puddle can create an alkaline condition for the bleaching step. Therefore, adding a dispense of pH adjust buffer (250 mM or 500 mM Tris) to the puddle prior to dispensing the bleaching reagent was evaluated. Additionally, the effect of puddle composition on bleaching performance was assessed by replacing the nominal Reaction Buffer (Tris-based buffer pH 7.6 comprising BRIJ-35 detergent) puddle with other bulk reagents, such as CC1 (a Tris-Borate-EDTA-based buffer pH 8.55), EZ Prep (an aqueous composition of PROCLIN300 biocide and COLATERGE low foam surfactant), or SSC (sodium chloride sodium citrate-based buffer pH 7).

Single slides of three MTBs were tested with Reaction Buffer, EZ Prep, and CC1 puddles and application of the pH adjust buffer (250 mM or 500 mM Tris) followed by application of 12.5% H₂O₂ in Tris pH 9 (final on-slide concentration 2.5% H₂O₂) for 92 minutes at 37° C. Single slides of MTB E were also tested with Reaction Buffer, CC1, and EZ Prep puddles and application of pH adjust buffer (250 mM Tris only) followed by application of 12.5% H₂O₂ in water for 92 min at 37° C. The testing was performed on three additional MTBs in duplicate. During this testing, in addition to Reaction Buffer, CC1, and EZ Prep, SSC was also assessed as a reaction puddle. 500 mM Tris pH adjust buffer was tested followed by application of 12.5% H₂O₂ in water for 92 min at 37° C. For these MTBs, a bleached NRC was also included for each condition tested. All conditions evaluated were compared to the nominal bleaching condition: 10% H₂O₂ diluted in water dispensed into a 300 μL puddle of Reaction Buffer (final on-slide concentration 2.5% H₂O₂), without application of the pH adjust buffer. Results are shown at Table 14:

TABLE 14

| | | pH | | | | | | |
|---|---|---|---|---|---|---|---|---|
| | | Adjust | | Tissue | Tissue | Tissue | Tissue | Tissue |
| MTB | H₂O₂ | Buffer | Puddle | 1 | 2 | 3 | 4 | 5 |
| 1 | 10% | N/A | Rxn | N/A | A | A | A | A |
| | | | Buffer | | | | | |
| | 12.5% | 250 mM | CC1 | N/A | A | A | A | A |
| | | Tris | EZ Prep | N/A | A | A | A | A |
| | | | Rxn | N/A | A | A | A | A |
| | | | Buffer | | | | | |
| | | 500 mM | CC1 | N/A | A | A | A | A |
| | | Tris | EZ Prep | N/A | A | A | A | A |
| | | | Rxn | N/A | A | A | A | A |
| | | | Buffer | | | | | |
| 2 | 10% | N/A | Rxn | N/A | A | A | A | A |
| | | | Buffer | | | | | |
| | 12.5% | 250 mM | CC1 | U | A | A | A | A |
| | | Tris | EZ Prep | A | A | A | A | A |
| 3 | 10% | N/A | Rxn | A | A | N/A | N/A | A |
| | | | Buffer | | | | | |
| | 12.5% | 250 mM | CC1 | A | A | N/A | N/A | A |
| | | Tris | EZ Prep | A | A | N/A | N/A | A |
| | | | Rxn | A | A | N/A | N/A | A |
| | | | Buffer | | | | | |
| | | 500 mM | CC1 | A | A | N/A | N/A | A |
| | | Tris | EZ Prep | A | A | N/A | N/A | A |
| | | | Rxn | A | A | N/A | N/A | A |
| | | | Buffer | | | | | |
| 4 | 10% | N/A | Rxn | A | N/A | A | A | A |
| | | | Buffer | | | | | |
| | 12.5% | 250 mM | CC1 | A | N/A | A | A | A |
| | | Tris | EZ Prep | A | N/A | A | A | A |
| | | | Rxn | A | N/A | A | A | A |
| | | | Buffer | | | | | |
| | | 500 mM | CC1 | A | N/A | A | A | A |
| | | Tris | EZ Prep | A | N/A | A | A | A |
| | | | Rxn | A | N/A | A | A | A |
| | | | Buffer | | | | | |
| 5 | 10% | N/A | Rxn | A | A | A | A | A |
| | | | Buffer | | | | | |
| | 12.5% | 500 mM | CC1 | NE | A | A | A | A |
| | | Tris | EZ Prep | NE | A | NE | U | A |
| | | | Rxn | NE | A | A | A | A |
| | | | Buffer | | | | | |
| | | | SSC | NE | NE | NE | NE | U |
| 6 | 10% | N/A | Rxn | A | A | N/A | A | A |
| | | | Buffer | | | | | |
| | 12.5% | 500 mM | CC1 | U | A | N/A | NE | |
| | | Tris | EZ Prep | U | NE | N/A | NE | NE |
| | | | Rxn | A | A | N/A | NE | A |
| | | | Buffer | | | | | |
| | | | SSC | NE | NE | N/A | NE | NE |
| 7 | 10% | N/A | Rxn | A | A | A | NE | A |
| | | | Buffer | | | | | |
| | 12.5% | 500 mM | CC1 | A | A | NE | NE | U |
| | | Tris | EZ Prep | NE | A | NE | NE | U |
| | | | Rxn | A | A | A | NE | U |
| | | | Buffer | | | | | |
| | | | SSC | A | A | NE | NE | U |

A: Acceptable;
U: Unacceptable;
N/A: Tissue cut through;
N/E: Unevaluable due to tissue wash off

Irrespective of MTB, a reaction puddle of SSC with pH adjust buffer resulted in the wash-off of either the NRC or the LAG3-stained (or both) in all melanoma tissues in all three MTBs. Additionally, using EZ Prep or CC1 as the reaction puddle yielded a loss of at least one tissue on each of the MTBs. The nominal bleaching condition only displayed tissue loss under circumstances where there was universal loss associated with that tissue across all of the conditions tested. Moreover, the Reaction Buffer puddle with a pH adjust buffer dispense demonstrated tissue loss on one MTB in addition to tissue shredding on another. These results suggest that Reaction Buffer is more suitable as the reaction puddle for the bleaching process compared to CC1, SSC or EZ Prep.

For slides bleached with the nominal condition, LAG3 IC staining was concordant (≤0.5 pt.) compared to no bleach slide, when applicable.

The LAG3 IC stain intensity of the high melanin case in MTB 6 bleached with the pH adjust buffer was 1 pt. lower compared to the nominal condition. In addition, there was 1 pt. decrease in tonsil IC stain intensity of MTB F2 bleached with pH adjust buffer compared to the no bleach slide.

When comparing high melanin cases, bleaching with the pH adjust buffer produced a greater reduction in melanin coverage (˜20%) in two MTBs. However, the melanin depigmentation performed in the Reaction Buffer puddle with or without the addition of the pH adjust buffer was sufficient for the interpretation of LAG3. These results suggests that the nominal condition produces sufficient depigmentation for the interpretation of LAG3. Moreover, changing the configuration of the system to add an additional pH adjust buffer may improve the residual melanin, but also may have a negative impact on the tissue and the LAG3 staining.

Finally, the impact of diluent composition was evaluated by directly comparing 10% H₂O₂ formulated in either deionized water or 10 mM Tris, compared to the application of the pH adjust buffer (250 mM or 500 mM). Duplicate slides of four melanoma MTBs were tested with the conditions listed in Table 15.

TABLE 15

| | | Additional Tris | | |
|---|---|---|---|---|
| Stock | | Buffer Added | | |
| H₂O₂ | Diluent | (mM) | pH at 20° C. | pH at 37° C. |
| 10% | 10 mM Tris9 | N/A | 7.41 | 7.05 |
| 10% | H₂O | N/A | 7.4 | 7.02 |
| 12.5% | H₂O | 250 | 8.06 | 7.7 |
| 12.5% | H₂O | 500 | 8.34 | 8.02 |

pH adjust buffer (250 mm or 500 mM Tris) was applied (when applicable) to a Reaction Buffer puddle, followed by application of the bleaching reagent, and incubated for 92 minutes at 37° C. All conditions were compared with the nominal bleaching condition: single dispense of 10% H₂O₂ diluted in water into 300 μL of reaction buffer, an effective concentration of 2.5% H₂O₂. For the addition of pH adjust buffer, H₂O₂ was formulated at 12.5% to have the same effective concentration of 2.5% in the puddle compared to the nominal condition. The pH of each formulation at room temperature was measured offline. The bleaching procedure was modified to accommodate the additional pH adjust buffer dispense in the bleaching reaction puddle. Results are shown at Table 16.

TABLE 16

| MTB | Condition | Tissue 1 | Tissue 2 | Tissue 3 | Tissue 4 | Tonsil |
|---|---|---|---|---|---|---|
| 1 | 10% in | Acceptable | Acceptable | Acceptable | Acceptable | Acceptable |
| | DI H₂O | | | | | |
| | 10% in | Acceptable | Acceptable | Acceptable | Acceptable | Acceptable |
| | Tris pH 9 | | | | | |
| | 12.5% in | Acceptable | Acceptable | Acceptable | Acceptable | Acceptable |
| | DI H₂O | | | | | |
| | 12.5% in | Acceptable | Acceptable | Acceptable | Acceptable | Acceptable |
| | Tris pH 9 | | | | | |
| 2 | 10% in | Acceptable | Acceptable | Acceptable | Acceptable | Acceptable |
| | DI H₂O | | | | | |
| | 10% in | Acceptable | Acceptable | Acceptable | Acceptable | Acceptable |
| | Tris pH 9 | | | | | |
| | 12.5% in | Acceptable | Acceptable | Acceptable | Acceptable | Acceptable |
| | DI H₂O | | | | | |
| | 12.5% in | Acceptable | Acceptable | Acceptable | Acceptable | Acceptable |
| | Tris pH 9 | | | | | |
| 3 | 10% in | Acceptable | Acceptable | NE | Acceptable | Acceptable |
| | DI H₂O | | | | | |
| | 10% in | Acceptable | Acceptable | NE | Acceptable | Acceptable |
| | Tris pH 9 | | | | | |
| | 12.5% in | Acceptable | Acceptable | NE | Acceptable | Acceptable |
| | DI H₂O | | | | | |
| | 12.5% in | Acceptable | Acceptable | NE | Acceptable | Acceptable |
| | Tris pH 9 | | | | | |
| 4 | 10% in | Acceptable | Acceptable | Acceptable | Acceptable | Acceptable |
| | DI H₂O | | | | | |
| | 10% in | Acceptable | Acceptable | Acceptable | Acceptable | Acceptable |
| | Tris pH 9 | | | | | |
| | 12.5% in | Acceptable | Acceptable | Acceptable | Acceptable | Acceptable |
| | DI H₂O | | | | | |
| | 12.5% in | Acceptable | Acceptable | Acceptable | Acceptable | Acceptable |
| | Tris pH 9 | | | | | |

NE: Not evaluated due to the presence of tissue necrosis

All bleaching conditions tested demonstrated similar bleaching performance and LAG3 expression in the moderate and low/no melanin cases across all MTBs enrolled. The high melanin-expressing case in MTBs 2-4 bleached with ‘10% H₂O₂ in H₂O+500 mM Tris’ demonstrated a complete removal of melanin in at least one of the duplicate LAG3-stained slides compared to incomplete but acceptable depigmentation observed in other conditions tested. However, this marginal improvement in bleaching performance did not improve the ability to read specific LAG3 staining, as LAG3 expression was interpretable across all test conditions. The IC staining on one of the tissue in MTB 2 was at 1 pt. with 10% H₂O₂ in DI Water and at 2 pt. with rest of the formulations. Since the non-bleached slide is not evaluable for IC staining, there is no control for IC on this case. However, 14 out of 15 melanomas across four MTBs demonstrated identical IC staining across all four formulations. Moreover, reader scored the IC staining at 1 pt. increments. Thus, the 1 pt. difference between formulations was considered comparable.

### Example 7: Effect of Bleaching Before or after Antigen Retrieval

Additional testing was executed to evaluate the impact of antigen retrieval pre vs. post bleach. Testing was performed on two MTBs. One slide per MTB was bleached either pre- or post-antigen retrieval (64 min CC1), followed by staining with LAG3 or Rabbit Monoclonal Negative Control Ig. One slide per MTB was also stained with LAG3 without bleaching to serve as non-bleach control. Results are shown in Tables 17 & 18.

TABLE 17
Effects of Antigen Retrieval: Additional Evaluation
- Immune Cell Staining Intensity Acceptability

| | | AR | Tissue | Tissue | Tissue | Tissue | |
|---|---|---|---|---|---|---|---|
| MTB | Order | Time | 1 | 2 | 3 | 4 | Tonsil |
| 1 | Pre | 64 min | A | A | A | A | A |
| | CC1 | | | | | | |
| | Post | 64 min | A | A | A | A | A |
| | CC1 | | | | | | |
| 2 | Pre | 64 min | A | A | A | A | A |
| | CC1 | | | | | | |
| | Post | 64 min | A | A | UA | A | A |
| | CC1 | | | | | | |

TABLE 18
TABLE 11.2.2: Effects of Antigen Retrieval:
Additional Evaluation - Melanin Acceptability

| | | AR | | Tissue | Tissue | Tissue | Tissue |
|---|---|---|---|---|---|---|---|
| MTB | Order | Time | Ab | 1 | 2 | 3 | 4 |
| 1 | Pre | 64 min | NRC | A | A | A | A |
| | CC1 | 64 min | LAG3 | A | A | A | A |
| | Pre | 64 min | NRC | UA | UA | A | A |
| | CC1 | 64 min | LAG3 | UA | UA | A | A |
| 2 | Pre | 64 min | NRC | UA | A | A | A |
| | CC1 | 64 min | LAG3 | UA | A | A | A |
| | Post | 64 min | NRC | UA | UA | UA | A |
| | CC1 | 64 min | LAG3 | UA | UA | UA | A |

*LAG3 Melanin acceptability was scored as A if the melanin intensity was ≤ 1 point.

Bleaching performance was deemed acceptable across all tissues bleached pre-CC1 except for one tissue (Tissue 1, MTB 2), which was deemed unacceptable due to the bleaching reagent decreasing over all melanin intensity only 0.75 pt and decreasing the melanin percent area by only 5% when compared to an unbleached reference. Bleaching performance in tissues bleached post-antigen retrieval were deemed unacceptable in tissues with moderate to high melanin levels; residual melanin was unchanged, less than 1.0 pt. or 15% different relative to non-bleached reference slides, and/or LAG3 staining was non-evaluable through the residual melanin. Minimal changes were observed across both MTBs with respect to both immune cell staining intensity and percent of immune cells stained between the bleaching pre-CC1 and bleaching post-CC1 conditions. Two bleached pre-CC1 cases (Tissues 2 and 3 in MTB 2) showed 0.25 pt. increase in immune cell stain intensity over their bleached post-CC1 counterparts. Tissue 4 in MTB 2 was the only case that showed a difference in percent immune cell staining with a 1% increase over bleaching post-CC1. Background staining was acceptable across all tissues.

### Example 8: Sequential Bleaching

The objective of this testing was to evaluate the bleaching performance when washing step is integrated in the bleaching step and whether the washing step improved the bleaching performance at high temperature.

For the evaluation of washing between sequential bleaching steps, slides were incubated with the respective formulation of the bleaching reagent for 44 minutes. Then the slides were rinsed with Reaction Buffer and adjusted to the optimal slide volume with the Reaction Buffer. Respective bleaching reagent was then re-applied and the slides were incubated for an additional 44 minutes. The incubation time of 44 minutes was selected so that the total incubation time was comparable to the nominal time of 92 minutes. One slide each was bleached with and without LAG3 clone SP464 following the bleaching process. Table 19 summarizes all reaction conditions tested and the corresponding results.

TABLE 19

| | | | Tissue | Tissue | Tissue | Tissue | |
|---|---|---|---|---|---|---|---|
| H₂O₂ | Temp. | Time | 1 | 2 | 3 | 4 | Tonsil |
| 1% | 50° C. | 92 min | A | A | A | A | A |
| | | 2 × 44 min | A | A | U | A | A |
| | 60° C. | 92 min | A | A | U | A | A |
| | | 2 × 44 min | A | A | U | A | A |
| | 80° C. | 92 min | A | A | U | A | A |
| | | 2 × 44 min | A | U | U | A | U |
| 5% | 50° C. | 92 min | A | A | A | A | A |
| | | 2 × 44 min | A | A | A | A | A |
| | 60° C. | 92 min | A | A | U | A | A |
| | | 2 × 44 min | U | A | U | A | A |
| | 80° C. | 92 min | U | U | U | U | U |
| | | 2 × 44 min | U | U | U | U | U |
| 10% | 50° C. | 92 min | A | A | A | A | A |
| | | 2 × 44 min | A | A | A | A | A |
| | 60° C. | 92 min | U | U | A | A | A |
| | | 2 × 44 min | U | U | U | U | U |
| | 80° C. | 92 min | U | U | U | U | U |
| | | 2 × 44 min | U | U | U | U | U |
| | 37° C. | 92 min | A | A | A | A | A |
| | (Nominal) | | | | | | |

Severe morphological damage was observed at 80° C., regardless of the H₂O₂ concentration or washing step. Moreover, some morphological damage and loss of antigenicity was seen on some tissues at 60° C. There was no significant difference in bleaching performance between slides incubated for 92 minutes and the slides beached with the intermediate wash step. Although 1% and 5% H₂O₂ sufficiently removed melanin for LAG3 signal to be easily assessed, melanin removal was close to complete in slides bleached with 10% H₂O₂ relative to 5% and 1% H₂O₂ concentrations. Slides bleached with 5% H₂O₂ in Tris pH 9 at 50° C. for 92 minutes produced comparable bleaching and LAG3 staining to nominal condition (10% H₂O₂, 37° C., 92 min).

### Example 9: Stability

The objective of this study was to access the stability of 10% H₂O₂ in various formulations using a heat stress model.

Accelerated stability testing was performed on multiple formulations of H₂O₂ using a heat-stress model. This was accomplished by storing formulated reagent dispensers (used for functional testing) and formulated reagent in 100 ml bottles (for analytical testing) at elevated temperatures for extended periods. See Table 20 for details on formulation, temperature, time-points and samples.

TABLE 20

| H₂O₂ | Temperature | | |
|---|---|---|---|
| Formulations | (° C.) | | Time Points Tested |
| 10% in 10 mM | 2-8° | C. | Day 0, 3*, 5, 8, 10, 32, 45, 60** |
| Tris pH 9 | 30° | C. | Day 5, 10 |
| | 37° | C. | Day 5, 8, 10, 32, 45, 60* |
| | 45° | C. | Day 3*, 5, 8, 10, 32, 45, 60* |
| 10% in DI | 2-8° | C. | Day 0, 3*, 5, 8, 10, 32, 45, 60** |
| Water | 30° | C. | Day 5, 10 |
| | 37° | C. | Day 5, 8, 10, 32, 45, 60** |
| | 45° | C. | Day 3*, 5, 8, 10, 32, 45, 60** |
| 10% in 1X PBS | 2-8° | C. | Day 0, 3, 5, 8, 10 |
| pH 8 | 30° | C. | Day 5, 10 |
| | 37° | C. | Day 5, 8, 10 |
| | 45° | C. | Day 3, 5, 8, 10 |
| 10% in | 2-8° | C. | Day 0, 5, 10*** |
| Reaction Buffer | 30° | C. | Day 5, 10*** |
| 10% in CC1 | 2-8° | C. | Day 0, 5, 10*** |
| | 30° | C. | Day 5, 10** |
| 10% in 10 mM | 2-8° | C. | Day 0, 10, 20, 30 |
| Tris pH 9 | 60° | C. | Day 10, 20, 30 |
| 10% in DI | 2-8° | C. | Day 0, 10, 20, 30 |
| Water | 60° | C. | Day 10, 20, 30 |

Accelerated stability testing was first conducted on five formulations of H₂O₂ at 30° C., 37° C. and 45° C. for 45 days. To further access the degradation of H₂O₂, testing was also performed on two formulations stored at 60° C. for 30 days. Dispensers and reagent bottles were kept in incubators at 30° C., 37° C., 45° C., and 60° C. until the day of the test; once removed for testing, dispensers and bottles were stored at 2-8° C. until the completion of the study. A dispenser and bottle formulated on Day 0 was stored at 2-8° C. for the duration of the study and used as reference for each time point. At each time point, functional testing was performed to evaluate the bleaching and LAG3 assay performance; the nominal bleaching protocol of 92 minutes at 37° C. was employed for each condition and time-point. Analytical testing (pH measurement and titration) was also performed to evaluate the change in pH value and H₂O₂ concentration with respect to Day 0.

Cerium (IV) Sulfate titration method was used to measure the concentration of both the stressed and non-stressed formulated product at each time point. In addition, pH measurement of each of the tested reagent was performed using calibrated pH meter.

At each time point, slides were stained with LAG3 (SP464) after bleaching with each of the heat-stressed bleaching reagent. A single slide was bleached with non-stressed bleaching reagent of each formulation (stored at 2-8° C.) to serve as a reference. Melanin intensity, melanin coverage as well as LAG3 stain intensity and IC percentage were captured.

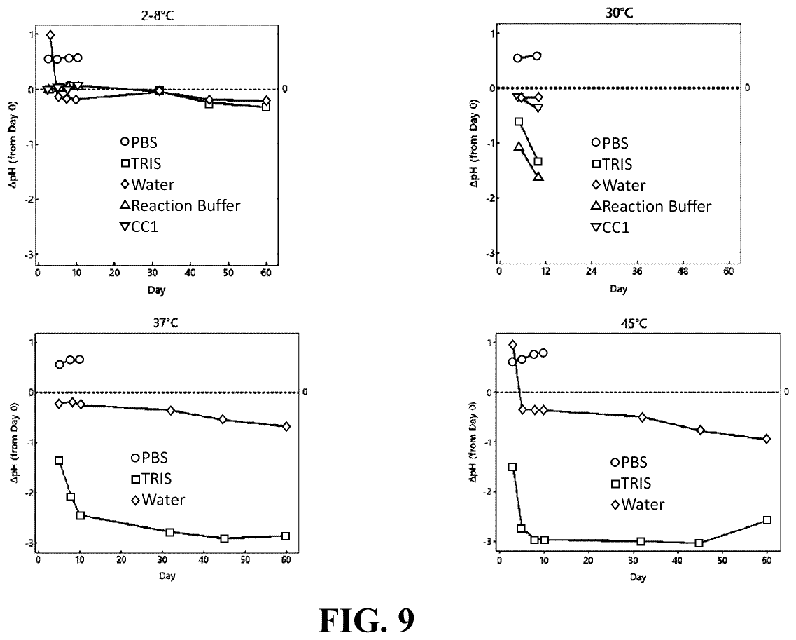

The pH value of the bleaching solution is directly dependent on the temperature at which it is measured. For Study 1, the heat-stressed reagents were not brought to room temperature prior to performing the pH measurement. Therefore, a ΔpH methodology (normalizing pH values to a theoretical Day 0 pH) was employed to compare the change in pH across all time points. Results are shown at FIG. 9 and Table 21.

TABLE 21

| | | | Δ pH Relative to Theoretical Day 0 pH | | | | | | |
|---|---|---|---|---|---|---|---|---|---|
| | | | Day | Day | Day | Day | Day | Day | Day |
| Condition | | Diluent | 3 | 5 | 8 | 10 | 32 | 45 | 60 |
| 2-8° | C. | PBS | 0.56 | 0.55 | 0.59 | 0.58 | N/A | N/A | N/A |
| | | Tris | 0.01 | 0.02 | 0.12 | 0.07 | −0.04 | −0.24 | −0.32 |
| | | Water | 1 | −0.13 | −0.15 | −0.18 | −0.05 | −0.18 | −0.21 |
| | | Reaction | N/A | 0.04 | N/A | 0.05 | N/A | N/A | N/A |
| | | Buffer | | | | | | | |
| | | CC1 | N/A | 0.02 | N/A | 0.06 | N/A | N/A | N/A |
| 30° | C. | PBS | N/A | 0.54 | N/A | 0.60 | N/A | N/A | N/A |
| | | Tris | N/A | −0.61 | N/A | −1.3 | N/A | N/A | N/A |
| | | Water | N/A | −0.18 | N/A | −0.17 | N/A | N/A | N/A |
| | | Reaction | N/A | −1.1 | N/A | −1.6 | N/A | N/A | N/A |
| | | Buffer | | | | | | | |
| | | CC1 | N/A | −0.18 | N/A | −0.38 | N/A | N/A | N/A |
| 37° | C. | PBS | N/A | 0.58 | 0.64 | 0.65 | N/A | N/A | N/A |
| | | Tris | N/A | −1.4 | −2.1 | −2.4 | −2.8 | −2.9 | −2.9 |
| | | Water | N/A | −0.23 | −0.19 | −0.26 | −0.36 | −0.56 | −0.68 |
| 45° | C. | PBS | 0.62 | 0.66 | 0.78 | 0.79 | N/A | N/A | N/A |
| | | Tris | −1.49 | −2.74 | −2.96 | −2.96 | −3.00 | −3.03 | −2.58 |
| | | Water | 0.93 | −0.35 | −0.34 | −0.37 | −0.50 | −0.78 | −0.95 |

N/A: Not Measured

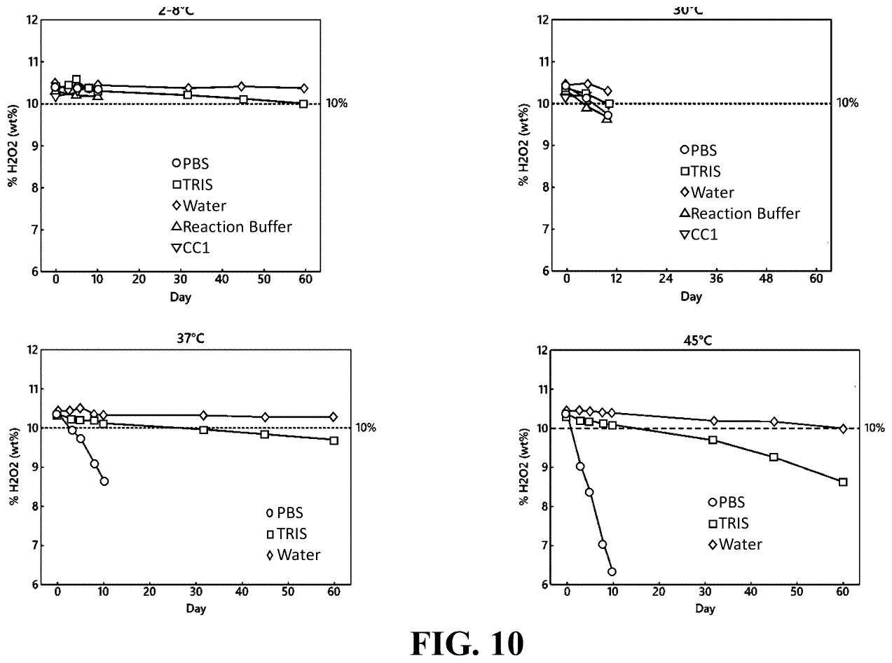

The concentrations of hydrogen peroxide in each of the solutions was determined utilizing a Cerium (IV) Sulfate redox titration and are listed in Table 22. The change in concentration over time is illustrated in FIG. 10; A reference line (red, dashed) at 10% H₂O₂ is included.

TABLE 22

| | | | H₂O₂ Concentration (%) | | | | | | | |
|---|---|---|---|---|---|---|---|---|---|---|
| | | | Day | Day | Day | Day | Day | Day | Day | Day |
| Condition | | Diluent | 0 | 3 | 5 | 8 | 10 | 32 | 45 | 60 |
| 2-8° | C. | PBS | 10.40 | 10.39 | 10.34 | 10.35 | 10.34 | N/A | N/A | N/A |
| | | Tris | 10.36 | 10.43 | 10.55 | 10.32 | 10.30 | 10.20 | 10.12 | 10.00 |
| | | Water | 10.44 | 10.35 | 10.43 | 10.37 | 10.44 | 10.37 | 10.41 | 10.37 |
| | | Reaction | 10.30 | N/A | 10.19 | N/A | 10.18 | N/A | N/A | N/A |
| | | Buffer | | | | | | | | |
| | | CC1 | 10.18 | N/A | 10.26 | N/A | N/A | N/A | N/A | N/A |
| 30° | C. | PBS | 10.40 | N/A | 10.10 | N/A | 9.73 | N/A | N/A | N/A |
| | | Tris | 10.36 | N/A | 10.22 | N/A | 9.98 | N/A | N/A | N/A |
| | | Water | 10.44 | N/A | 10.48 | N/A | 10.29 | N/A | N/A | N/A |
| | | Reaction | 10.30 | N/A | 9.92 | N/A | 9.66 | N/A | N/A | N/A |
| | | Buffer | | | | | | | | |
| | | CC1 | 10.18 | N/A | 10.19 | N/A | N/A | N/A | N/A | N/A |
| 37° | C. | PBS | 10.40 | 9.95 | 9.74 | 9.12 | 8.68 | N/A | N/A | N/A |
| | | Tris | 10.36 | 10.23 | 10.17 | 10.21 | 10.12 | 9.96 | 9.84 | 9.7 |
| | | Water | 10.44 | 10.43 | 10.53 | 10.35 | 10.33 | 10.32 | 10.28 | 10.28 |
| 45° | C. | PBS | 10.40 | 9.05 | 8.40 | 7.05 | 6.33 | N/A | N/A | N/A |
| | | Tris | 10.36 | 10.2 | 10.2 | 10.11 | 10.09 | 9.69 | 9.26 | 8.63 |
| | | Water | 10.44 | 10.45 | 10.43 | 10.41 | 10.39 | 10.19 | 10.17 | 10.00 |

At 2-8° C., the H₂O₂ concentration of both the Tris and water formulations were stable for 45 days. Such formulations showed no sign of decomposition when stored at 30° C. and 37° C. by Day 32. H₂O₂ concentration in water remained constant (˜10%) at 37° C. and 45° C. for 45 days. At day 45, the Tris solution exhibited a ˜0.5% and ˜1.1% decrease in % H₂O₂ at 37° C. and 45° C., respectively. The decomposition of H₂O₂ in Tris became more significant by Day 60 (at 45° C.). Reaction buffer and PBS solutions exhibit a 0.7% decrease in H₂O₂ concentration by Day 10 when stored at 30° C. This gradual decay of the H₂O₂ in PBS became more significant when stored at 37° C. and 45° C. The Reaction Buffer and PBS solutions exhibited a 0.7% decrease in H₂O₂ concentration by Day 10 when stored at 30° C. This gradual decay of the H₂O₂ in PBS became more significant when stored at 37° C. and 45° C.

Functional testing results are summarized in Table 23.

TABLE 23

| | | | | | Tissue | Tissue | Tissue | Tissue | |
|---|---|---|---|---|---|---|---|---|---|
| Time | MTB | Diluent | Temp. | | 1 | 2 | 3 | 4 | Tonsil |
| Day | 1 | PBS pH 8 | 2-8° | C. | A* | A | A | A | A |
| 3 | | | 45° | C. | A | A | A | A | A |
| | | Tris pH 9 | 2-8° | C. | A | A | A | A | A |
| | | | 45° | C. | A | A | A | A | A |
| | | DI Water | 2-8° | C. | A | A | A | A | A |
| | | | 45° | C. | A* | A | A | A | A |
| Day | 1 | PBS pH 8 | 2-8° | C. | A | A | A | A | A |
| 5 | | | 37° | C. | A | A | A | A | A |
| | | | 45° | C. | U | A | A | A | A |
| | | Tris pH 9 | 2-8° | C. | A | A | A | A | A |
| | | | 37° | C. | A | A | A | A | A |
| | | | 45° | C. | A | A | A | A | A |
| | | DI Water | 2-8° | C. | A | A | A | A | A |
| | | | 37° | C. | A | A | A | A | A |
| | | | 45° | C. | A | A | A | A | A |
| | | Reaction | 2-8° | C. | A | A | A | A | A |
| | | Buffer | 30° | C. | A | A | A | A | A |
| | | CC1 | 2-8° | C. | A | A | A | A | A |
| | | | 30° | C. | A | A | A | A | A |
| Day | 1 | PBS pH 8 | 2-8° | C. | A | A* | A | A | A |
| 8 | | | 37° | C. | A | A | A | A | A |
| | | | 45° | C. | A | A | A* | A | A |
| | | Tris pH 9 | 2-8° | C. | A | A* | A* | A | A |
| | | | 37° | C. | A | A* | A* | A | A |
| | | | 45° | C. | A | A* | A* | A | A |
| | | DI Water | 2-8° | C. | A | A* | A* | A | A |
| | | | 37° | C. | A | A* | A* | A | A |
| | | | 45° | C. | A | A | A | A | A |
| Day | 1 | PBS pH 8 | 2-8° | C. | A | A | A | A | A |
| 10 | | | 30° | C. | A | A | A | A | A |
| | | | 37° | C. | A | A | A | A | A |
| | | | 45° | C. | A | A | A | A | A |
| | | Tris pH 9 | 2-8° | C. | A | A | A | A | A |
| | | | 30° | C. | A | A | A | A | A |
| | | | 37° | C. | A | A | A | A* | A |
| | | | 45° | C. | A | A | A | A* | A |
| | | DI Water | 2-8° | C. | A | A | A | A | A |
| | | | 30° | C. | A | A | A | A | A |
| | | | 37° | C. | A | A | A | A* | A |
| | | | 45° | C. | A | A | A | A* | A |
| | | Reaction | 2-8° | C. | A | A | A | A* | A |
| | | Buffer | 30° | C. | A | A | A | A* | A |
| | | CC1 | 2-8° | C. | A | A | A | A* | A |
| | | | 30° | C. | A | A | A | A* | A |
| Day | 1 | Tris pH 9 | 2-8° | C. | A | N/A | A | A | A |
| 32 | | | 37° | C. | A | N/A | A | A | A |
| | | | 45° | C. | A | N/A | A | A | A |
| | | DI Water | 2-8° | C. | A | N/A | A | A | A |
| | | | 37° | C. | A | N/A | A | A | A |
| | | | 45° | C. | A | N/A | A | A | A |
| | 2 | Tris pH 9 | 2-8° | C. | N/A | N/A | A | A | A |
| | | | 37° | C. | N/A | N/A | A* | A | A |
| | | | 45° | C. | N/A | N/A | A | A | A |
| | | DI Water | 2-8° | C. | N/A | N/A | A | A | A |
| | | | 37° | C. | N/A | N/A | A* | A | A |
| | | | 45° | C. | N/A | N/A | A | A | A |
| | 3 | Tris pH 9 | 2-8° | C. | N/A | N/A | N/A | A | A |
| | | | 37° | C. | N/A | N/A | N/A | A | A |
| | | | 45° | C. | N/A | N/A | N/A | A | A |
| | | DI Water | 2-8° | C. | N/A | N/A | N/A | A | A |
| | | | 37° | C. | N/A | N/A | N/A | A | A* |
| | | | 45° | C. | N/A | N/A | N/A | A | A |
| Day | 4 | Tris pH 9 | 2-8° | C. | A | A* | N/A | A* | A |
| 45 | | | 37° | C. | A | A* | N/A | A | A |
| | | | 45° | C. | A | A* | N/A | A* | A |
| | | DI Water | 2-8° | C. | A | A* | N/A | A* | A |
| | | | 37° | C. | A | A* | N/A | A* | A |
| | | | 45° | C. | A | A* | N/A | A* | A |

A: Acceptable;
U: Unacceptable;
N/A: Tissue exhaustion
*Slides with 1 pt. difference in IC staining compared to no bleach

At Day 3, 10% H₂O₂ in PBS pH 8 stored at 45° C. demonstrated a slight decrease in melanin bleaching relative to the water and Tris pH 9 diluents; however, this slight increase in melanin signal was not recapitulated at the Days 5, 8, or 10 time-points. Additionally, there was an increase in melanin intensity associated with H₂O₂ diluted in CC1 at Day 0 with MTBs P, S, and T relative to the other bleaching reagent formulations. Moreover, at Day 5, H₂O₂ in CC1 stored at 30° C. demonstrated a 1 pt. increase in melanin intensity over the other H₂O₂ formulations, but that observation did not repeat at Day 10.

The Arrhenius Model requires the assay to fail, presumably once the LAG3+ cells can no longer be observed or the epitope is damaged. Functional failure was not observed in any formulations by Day 10, therefore testing continued to Day 45. Based on the H₂O₂ titration data which indicated that H₂O₂ formulated in Tris pH 9 and DI Water were most stable, these two formulations were further tested at Days 32 and 45. Both formulations (Tris pH 9 and DI water) demonstrated concordant (≤0.5 pt IC SI) melanin bleaching and LAG3 staining, with almost close to complete bleaching in the high melanin cases. By Day 45, no functional failure (LAG3 epitope binding) or differences in melanin intensity that would preclude LAG3 interpretation using 10% H₂O₂ diluted in either H₂O or Tris-9 were observed. The analytical testing was continued until Day 60 for the two formulations. At Day 45, H₂O₂ in Tris pH 9 exhibited a ˜0.5% and ˜1.1% decrease in H₂O₂ concentration at 37° C. and 45° C., respectively. The decomposition of H₂O₂ in Tris pH 9 became more significant by Day 60 (at 45° C.) indicating water as the most stable diluent for H₂O₂.

### Example 10: Guardbanding

The objective of this study was to determine an acceptable range for formulation and protocol selectables: H₂O₂ concentration, bleaching incubation temperature and incubation time.

3 MTB's were enrolled and duplicate slides from each MTB were subjected to a various H₂O₂ concentrations, incubation temperatures, and incubation times followed by staining with LAG3 clone 17B4. A single slide was bleached with each test condition and then stained with NRC. See Table 24 for details on testing conditions.

TABLE 24

| Tested | H₂O₂ | | |
|---|---|---|---|
| Parameter | Concentration (%) | Temperature (° C.) | Time (min) |
| Concentration | 1 | 37 | 92 |
| | 4 | 37 | 92 |
| | 8 | 37 | 92 |
| | 10 | 37 | 92 |
| | 12 | 37 | 92 |
| | 15 | 37 | 92 |
| | 17 | 37 | 92 |
| | 20 | 37 | 92 |
| Temperature | 10 | 20 | 92 |
| | 10 | 37 | 92 |
| | 10 | 45 | 92 |
| | 10 | 55 | 92 |
| | 10 | 65 | 92 |
| | 10 | 75 | 92 |
| Time | 10 | 37 | 64 |
| | 10 | 37 | 72 |
| | 10 | 37 | 80 |
| | 10 | 37 | 92 |
| | 10 | 37 | 180 |

### Example 10A H₂O₂ Concentration

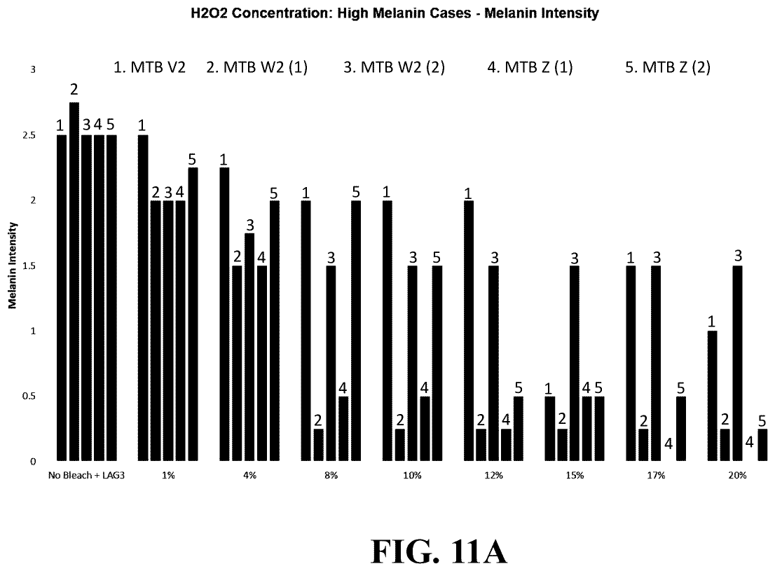

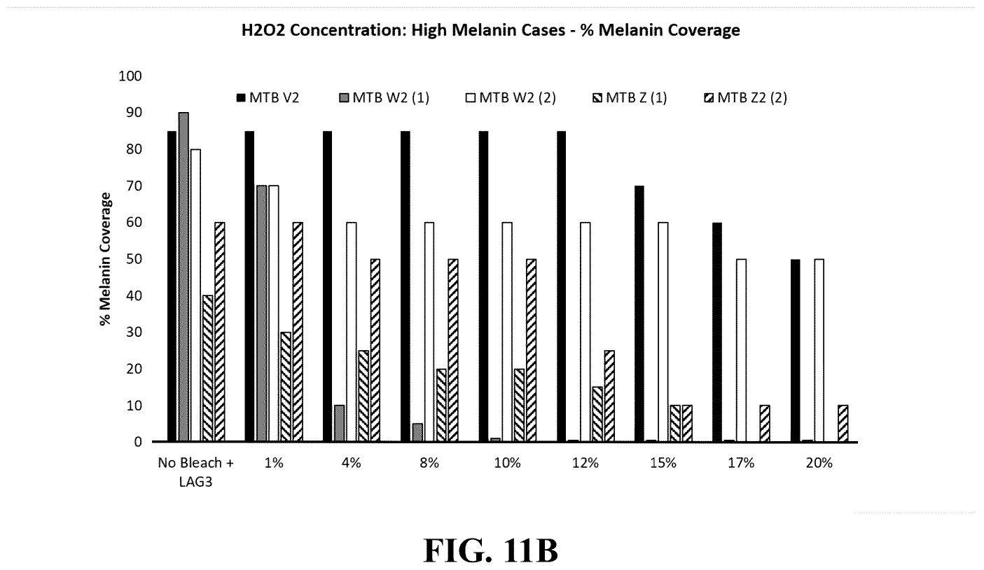

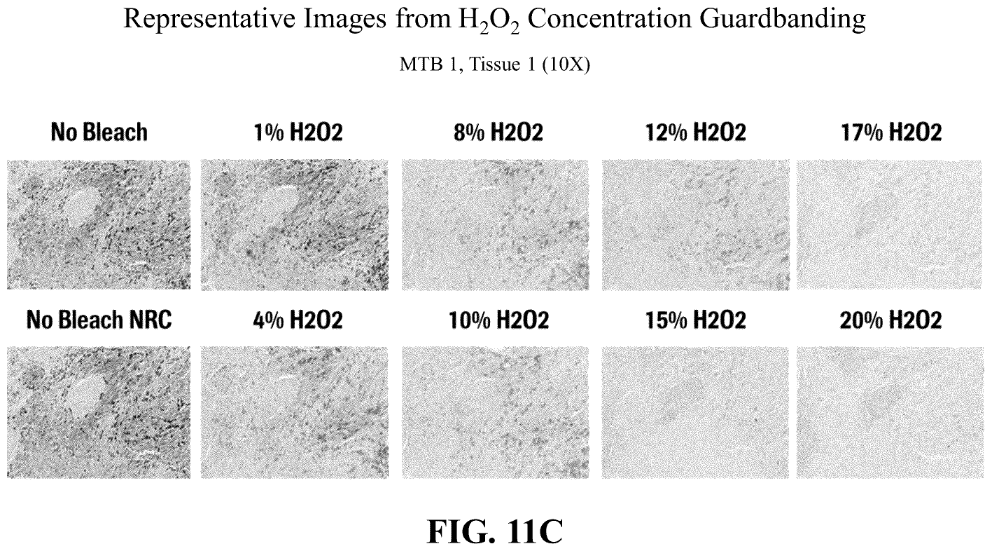

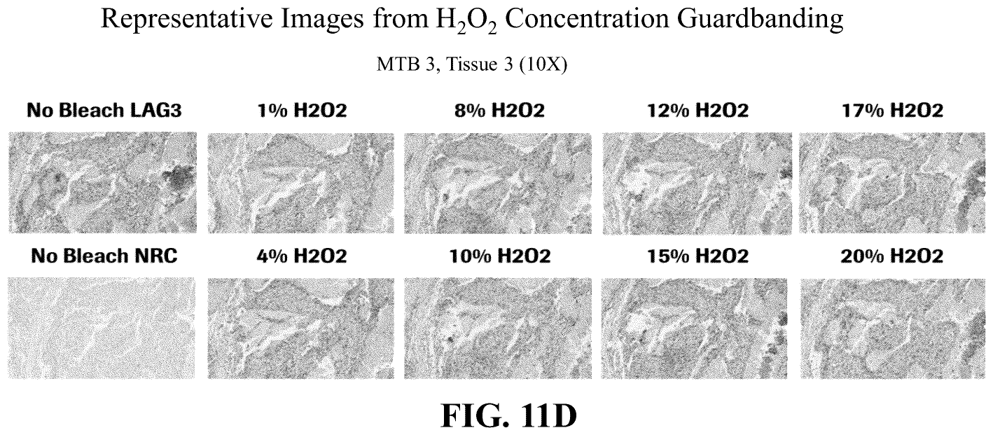

Results of the H₂O₂ guardbanding are shown at Table 25 and FIGS. 11A-11D.

TABLE 25

| MTB | [H₂O₂] | Tissue 1 | Tissue 2 | Tissue 3 | Tissue 4 | Tonsil |
|---|---|---|---|---|---|---|
| 1 | 1% | Acceptable | Acceptable | Acceptable | Acceptable | Acceptable |
| | 4% | Acceptable | Acceptable | Acceptable | Acceptable | Acceptable |
| | 8% | Acceptable | Acceptable | Acceptable | Acceptable | Acceptable |
| | 10% | Acceptable | Acceptable | Acceptable | Acceptable | Acceptable |
| | 12% | Acceptable | Acceptable | Acceptable | Acceptable | Acceptable |
| | 15% | Acceptable | Acceptable | Acceptable | Acceptable | Acceptable |
| | 17% | Acceptable | Acceptable | Acceptable | Acceptable | Acceptable |
| | 20% | Acceptable | Acceptable | Acceptable | Acceptable | Acceptable |
| 2 | 1% | Acceptable | Acceptable | Acceptable | Acceptable | Acceptable |
| | 4% | Acceptable | Acceptable | Acceptable | Acceptable | Acceptable |
| | 8% | Acceptable | Acceptable | Acceptable | Acceptable | Acceptable |
| | 10% | Acceptable | Acceptable | Acceptable | Acceptable | Acceptable |
| | 12% | Acceptable | Acceptable | Acceptable | Acceptable | Acceptable |
| | 15% | Acceptable | Acceptable | Acceptable | Acceptable | Acceptable |
| | 17% | Acceptable | Acceptable | Acceptable | Acceptable | Acceptable |
| | 20% | Acceptable | Acceptable | Acceptable | Acceptable | Acceptable |
| 3 | 1% | Acceptable | Acceptable | Acceptable | Acceptable | Acceptable |
| | 4% | Acceptable | Acceptable | Acceptable | Acceptable | Acceptable |
| | 8% | Acceptable | Acceptable | Acceptable | Acceptable | Acceptable |
| | 10% | Acceptable | Acceptable | Acceptable | Acceptable | Acceptable |
| | 12% | Acceptable | Acceptable | Acceptable | Acceptable | Acceptable |
| | 15% | Acceptable | Acceptable | Acceptable | Acceptable | Acceptable |
| | 17% | Unacceptable* | Acceptable | Acceptable | Acceptable | Acceptable |
| | 20% | Unacceptable* | Acceptable | Acceptable | Acceptable | Acceptable |

*Unacceptable due to morphological damage

All slides demonstrated sufficient bleaching that allowed for the interpretation of specific LAG3 DAB signal. Moreover, the expression was preserved in all slides relative to non-bleached reference. Following bleaching with the test conditions, all evaluable tissues demonstrated concordant LAG3 staining relative to non-bleached reference slide. FIG. 11A and FIG. 11B demonstrate the distribution of melanin intensity and percent coverage in five high melanin cases. Increasing the concentration of H₂O₂ to 17% and 20% resulted in unacceptable tissue damage/poor cellular morphology in high melanin case in MTB 3. Moreover, focal morphological damages were also noted by the reader in one of the tissues of MTB W1 with 17% and 20%, however, were still deemed acceptable by the reader.

The H₂O₂ concentrations of 1%-15% produced sufficient melanin bleaching and LAG3 staining performance was concordant to no bleach slides in all tissues of all three MTBs. While 15% produces close to complete removal of melanin, 8%-12% H₂O₂ demonstrates comparable level of residual melanin, see FIG. 11C and FIG. 11D.

### Example 10B: Incubation Temperature

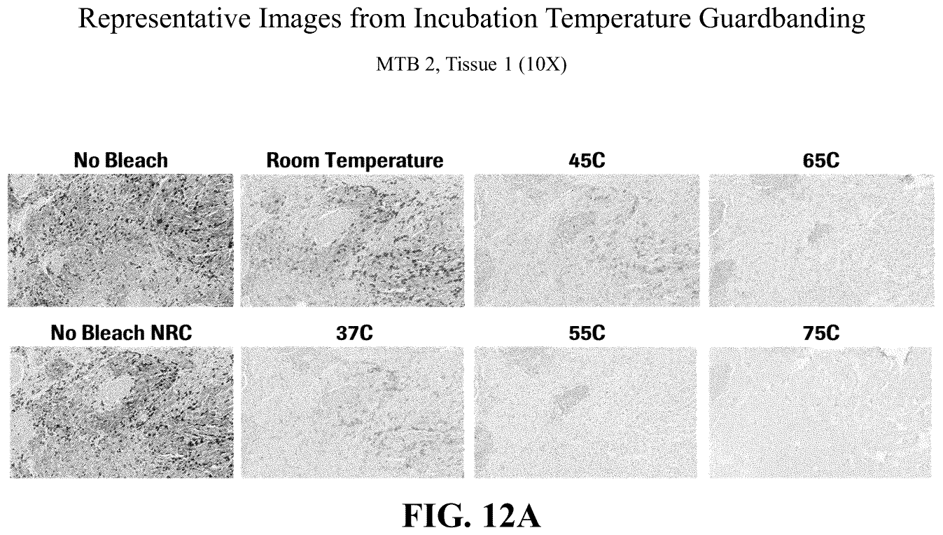

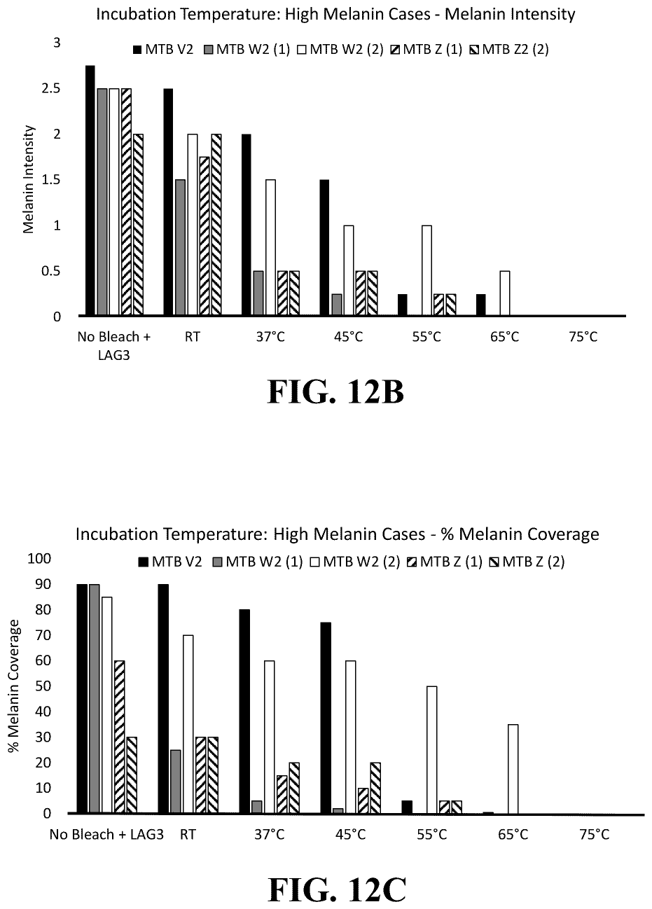

All slides bleached with parameters listed in Table 24 demonstrated sufficient bleaching that allowed for the interpretation of specific LAG3 DAB signal. When applicable, all tissues demonstrated concordance (within 0.5 pt.) with the no bleach slide. See Table 26 for the summary of the results and FIG. 12A for representative images from the study.

TABLE 26

| | Incubation | Tissue | Tissue | Tissue | Tissue | |
|---|---|---|---|---|---|---|
| MTB | Temp (° C.) | 1 | 2 | 3 | 4 | Tonsil |
| MTB | Room Temp | A | A | A | A | A |
| V2* | 37 | A | A | A | A | A |
| | 45 | A | A | A | A | A |
| | 55 | A | A | A | A | A |
| | 65 | A | U# | A | U# | U# |
| | 75 | U | N/A | N/A | N/A | N/A |
| MTB | Room Temp | A | A | A | A | A |
| W2* | 37 | A | A | A | A | A |
| | 45 | A | A | A | A | A |
| | 55 | U# | A | U# | A | A |
| | 65 | U# | A | U# | A | A |
| | 75 | N/A | U# | N/A | N/A | U# |
| MTB | Room Temp | A | A | A | A | A |
| Z | 37 | A | A | A | A | A |
| | 45 | A | A | A | A | A |
| | 55 | A | A | A | A | A |
| | 65 | U# | N/A*** | U# | U# | U# |
| | 75 | N/A | N/A | N/A | N/A | U# |

U = Unacceptable;
A = Acceptable
*No Bleach + LAG3 control IC SI = NE, MTB V2 tissue 1, MTB W2 tissues 1 & 2.
Used 37° C. (nominal) as reference.
#U due to morphological damage
N/A Tissue Wash off
N/A*** Majority of tumor washed off - no tumor present

FIGS. 12B and 12C demonstrates the distribution of melanin intensity and percent coverage in five high melanin cases of MTB 1-3. Bleaching performance at room temperature, 37° C., and 45° C. was comparable and IC staining was within 0.5 pt. relative to no bleach slide. However, in the slides incubated 37° C. and 45° C., the melanin intensity of the residual melanin decreased by 0.5-1.5 pt. and melanin coverage decreased by 10-15% when compared to slides incubated at room temperature. LAG3 staining in tissues bleached at 55° C. were concordant (within 0.5 pt.) with the no bleach slide for MTB's 1 and 3, however, two of five melanoma tissues associated with MTB 2 demonstrated either damaged tissue morphology or poor counterstain.

At 65° C. and 75° C., melanoma and tonsil samples from all three MTB's demonstrated extensive cellular damage and tissue wash off. Across all MTBs, 13 of 30 tissues demonstrated unacceptable tissue morphology while 12 out of 30 tissues were washed off during the bleaching/staining run. The results indicate that the incubation temperatures of room temperature up to 45° C. produces sufficient bleaching without compromising the staining performance and tissue integrity. However, melanin removal is more significant with the incubation temperatures of 37° C., and 45° C.

### Example 10C: Incubation Time

All slides bleached with parameters listed in Table 24 demonstrated sufficient bleaching that allowed for the interpretation of specific LAG3 signal. Moreover, the antigenicity of the tissue was preserved as LAG3 staining for all tissues were within 0.5 pt. from no bleach slides with the exception of Tissue 3 in MTB 3, which demonstrated a 0.75 pt. increase in LAG3 stain intensity at all incubation times compared to the non-bleached slide.

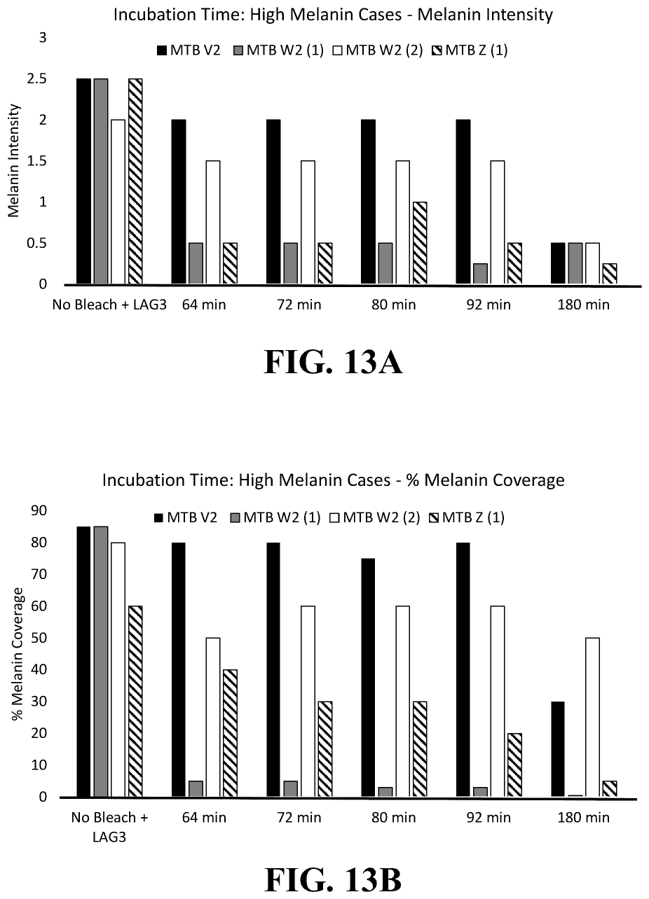

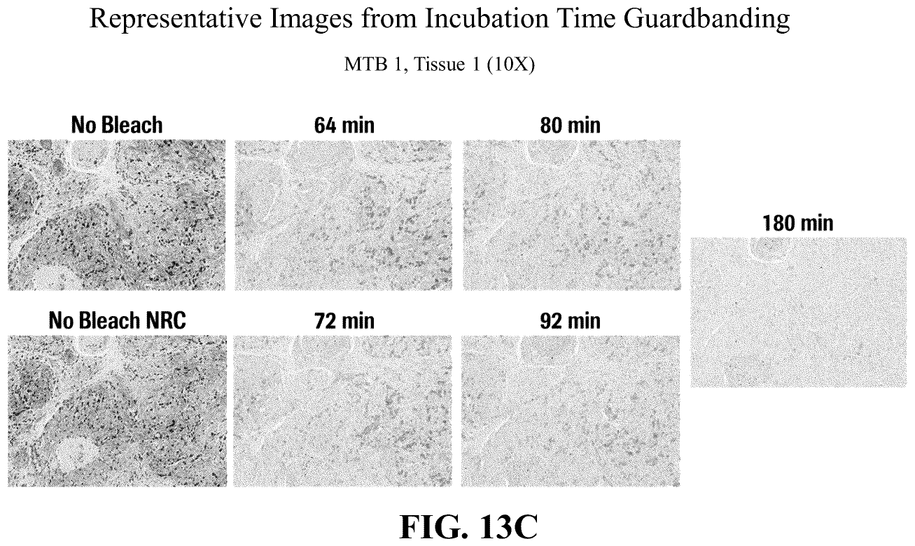

FIGS. 13A and 13B demonstrate the distribution of the melanin intensity and percent coverage in five high melanin cases of MTB 1-3. See Table 27 for the summary of the results and FIG. 13C for representative images from the study.

TABLE 27

| | Incubation | Tissue | Tissue | Tissue | Tissue | |
|---|---|---|---|---|---|---|
| MTB | Time (min) | 1 | 2 | 3 | 4 | Tonsil |
| 1 | 64 | A | A | A | A | A |
| | 72 | A | A | A | A | A |
| | 80 | A | A | A | A | A |
| | 92 | A | A | A | A | A |
| | 180 | A | A | A | A | A |
| 2 | 64 | A | A | A | A | A |
| | 72 | A | A | A | A | A |
| | 80 | A | A | A | A | A |
| | 92 | A | A | A | A | A |
| | 180 | A | A | A | A | A |
| 3 | 64 | A | NE | A* | A | A |
| | 72 | A | NE | A* | A | A |
| | 80 | A | NE | A* | A | A |
| | 92 | A | NE | A* | A | A |
| | 180 | A | NE | A* | A | A |

NE: Tumor cut through
*Immune cell staining intensity of the study slides is 0.75 pt. greater than the ″No Bleach + LAG3’ control

These data indicate that subjecting tissue to the nominal bleaching reagent formulation (10% H₂O₂) for 64 minutes and up to 180 minutes produced sufficient bleaching while preserving the LAG3 staining performance. However, the qualified reader commented that at 180 minutes, there was focal morphological damage in two melanoma tissues and tonsil in MTB 1. Nevertheless, the reader deemed the slides acceptable.

### REFERENCES

Chung et al., A melanin-bleaching methodology for molecular and histopathological analysis of formalin-fixed paraffin-embedded tissue, Laboratory Investigation, 2016, Vol. 96, pp. 1116-1127.
Foss, A. et al., Immunohistochemical techniques: the effect of melanin bleaching, Br. J. Biomed. Sci., 1995, Vol. 52, Issue 1, pp. 22-25.
Hu, L. et al., Int. J. Clin. Exp. Pathol. (2020) 13 (8), 2027-2034
Liu et al., Melanin Bleaching With Warm Hydrogen Peroxide and Integrated Immunohistochemical Analysis: An Automated Platform, International Journal of Surgical Pathology, 2018, Vol. 26, Issue 5, 410-416.
McGovern & Crocker, The Effect of Melanin Pigment Removal on the Peroxidase-Antiperoxidase Immunoperoxidase Technic, Am. J. Clin. Pathol. (1987), Vol. 88, Issue 4, pp. 480-483.
Manicam, C. et al., Effective Melanin Depigmentation of Human and Murine Ocular Tissues: An Improved Method for Paraffin and Frozen Sections, PLOS One (2014) 9 (7), e102512.
Orchard, Use of heat provides a fast and efficient way to undertake melanin bleaching with dilute hydrogen peroxide, Br. J. Biomed. Sci. 2007, 64 (2), 89-91
Orchard et al., Semi-automated standardisation of melanin bleaching procedures of heavily pigmented melanocytic lesions for immunohistochemical analysis on an automated platform, Br. J. Biomed. Sci. (2019), 76 (4), 172-177.

1. A method of bleaching melanin from a cellular sample, comprising contacting the cellular sample with an H₂O₂ bleaching solution comprising between about 1% to about 5% H₂O₂; and incubating the cellular sample at a temperature ranging from between about 20° C. to about 50° C. for a period of time ranging from about 8 minutes to about 180 minutes.

2. The method of claim 1, wherein the temperature ranges from about 30° C. to about 50° C.

3. The method of claim 1, wherein the H₂O₂ bleaching solution has a pH ranging from about 7 to about pH 9 at room temperature.

4. The method of claim 1, wherein the H₂O₂ bleaching solution comprises from about 7.5 mM to about 250 mM of Tris.

5. The method of claim 1 wherein the H₂O₂ bleaching solution comprises from about 7.5 to about 75 mM of Tris.

6. The method of claim 1, wherein the period of time ranges from about 60 to about 180 minutes.

7. An automated method of affinity staining a melanin-pigmented cellular sample, comprising causing an automated affinity staining apparatus to perform at least the following functions:
(a) performing the method of claim 1 on the melanin-pigmented cellular sample to obtain a bleached sample;
(b) performing an antigen retrieval procedure on the bleached sample to obtain a conditioned sample; and
(c) affinity staining the conditioned sample with a set of detection reagents to obtain a stained sample.

8. The method of claim 7, wherein the automated affinity staining apparatus comprises a reservoir comprising a stock buffer solution and a reservoir comprising a concentrated hydrogen peroxide stock solution at a concentration ranging from about 4% to about 20%, and wherein the aqueous H₂O₂ solution is obtained by mixing a volume of the hydrogen peroxide stock solution with a volume of the stock buffer solution.

9. The method of claim 8, wherein the hydrogen peroxide stock solution consists essentially of hydrogen peroxide and water.

10. The method of claim 9, wherein the water is deionized water.

11. The method of claim 8, wherein the hydrogen peroxide stock solution comprises about 0.5 mM Tris or less.

12. The method of claim 7, wherein (b) comprises washing the bleached sample during the incubation; and wherein the aqueous solution of hydrogen peroxide is replenished after the washing.

13. An automated affinity stainer comprising:
(a) a set of reagents comprising a concentrated H₂O₂ stock solution at a concentration ranging from about 4% to about 20%, a buffer solution, optionally a pH adjust buffer, and optionally a wash buffer; and
(b) a control system, wherein the control system includes instructions for performing a set of operations on a melanin-pigmented tissue, the set of operations comprising:
(b1) obtaining a H₂O₂ bleaching solution comprising between about 1% to about 5% of H₂O₂ by combining at least the concentrated H₂O₂ stock solution and the buffer solution; and
(b2) incubating a cellular sample in contact with the H₂O₂ bleaching solution at a temperature from about 20° C. to about 50° C. for a period of time in the range of about 8 minutes to about 180 minutes, wherein the incubation optionally comprises at least one wash with the wash buffer, and wherein the H₂O₂ bleaching solution in contact with the cellular sample is replenished after the wash.

14. The automated affinity stainer of claim 13, wherein the concentrated H₂O₂ stock solution has a pH ranging from about 7.4 to about 9.0.

15. The automated affinity stainer of claim 14, wherein the concentrated H₂O₂ stock solution consists essentially of hydrogen peroxide and deionized water.

16. The automated affinity stainer of claim 14, wherein the concentrated H₂O₂ stock solution comprises from about 0 mM to about 0.5 mM of Tris.

17. The automated affinity stainer of claim 13, wherein the stock buffer solution comprises up to about 250 mM of Tris.

18. The automated affinity stainer of claim 13, wherein the stock buffer solution comprises up to about 100 mM of Tris.

19. The automated affinity stainer of claim 18, wherein the stock buffer solution comprises about 10 to about 100 mM of Tris.

20. The automated affinity stainer of claim 13, wherein the stock pH adjust solution comprises from about 50 to about 500 mM of Tris at a pH of about 9.
